(19) United States
(12) Patent Application Publication
(10) Pub. No.: US 2026/0323471 A1
(43) Pub. Date: Oct. 15, 2026

(54) COMPUTER-BASED SYSTEMS FOR MANAGING COMMUNICATION DEVICES IN AN AD-HOC COMMUNICATION NETWORK AND METHODS OF USE THEREOF

(71) Applicant: FLVSH LLC, Oakland Gardens, NY (US)

(72) Inventors: Dawn Charles, Oakland Gardens, NY (US); Uri Charles, Brooklyn, NY (US)

(21) Appl. No.: 19/576,000

(22) Filed: Mar. 24, 2026

Related U.S. Application Data
(60) Provisional application No. 63/777,430, filed on Mar. 25, 2025.

(51) Int. Cl. H04W 40/02; H04W 84/02

(52) U.S. Cl. CPC H04W 40/02; H04W 84/022

(57) ABSTRACT

Systems and methods for managing communication devices in an ad-hoc mesh network using long-range (LoRa), low-power radios may include communication devices equipped with LoRa transceivers, processors, and memory, configured to operate as nodes in a decentralized network. Devices may iteratively maintain routing tables associating destination identifiers with next-hop neighbors and path cost metrics, compute path cost metrics based on aggregate transmission times, and forward data packets via optimal routes. Routing update packets may be transmitted using multiple spreading factors in a non-deterministic order, balancing channel occupancy and reducing collisions. The system may support multi-hop communication, dynamic topology adaptation, and encrypted data transmission for secure and resilient infrastructure-less connectivity. Applications may include disaster response, environmental monitoring, and/or remote communication. The disclosed system leverages LoRa radio long-range capabilities and mesh networking to provide scalable, low-cost, and/or robust communication solutions in areas with limited or no infrastructure.

### CROSS-REFERENCE TO RELATED APPLICATION

This application claims priority under 35 U.S.C. § 119 from Provisional Application Ser. No. 63/777,430 filed on Mar. 25, 2025, the disclosures of which are incorporated herein by reference.

### FIELD OF DISCLOSURE

The field of disclosure relates to wireless communication systems. More particularly, the field of disclosure relates to computer-based systems for managing communication devices in an ad-hoc communication network and methods of use thereof.

### BACKGROUND OF THE DISCLOSURE

Wireless communication systems are widely used to exchange information among mobile devices, sensors, and other electronic systems. Many such systems rely on fixed infrastructure, such as cellular base stations, wireless access points, or dedicated gateways, to provide connectivity and coordinate communications. In environments where such infrastructure is unavailable, damaged, impractical to deploy, or too costly to maintain, reliable communications may be limited or entirely unavailable.

Long-range, low-power wireless technologies have been developed for applications in which devices transmit relatively small amounts of data while operating under power, bandwidth, and coverage constraints. However, many conventional implementations remain dependent on centralized architectures or predefined network components, which may reduce their usefulness in environments requiring direct device-to-device communications. In addition, the characteristics of long-range, low-data-rate wireless communications may create challenges relating to latency, channel occupancy, interference, packet collisions, and changing link quality.

Ad hoc and mesh networking techniques have been proposed to extend communications beyond the range of a single wireless link, but such techniques may be difficult to implement efficiently in networks having constrained bandwidth, variable transmission times, and limited device resources. Devices participating in such networks may also be subject to regulatory constraints, power limitations, and dynamic topology changes that can adversely affect route selection, message delivery, and overall network performance.

Thus, there is a need in the art for systems and methods that improve wireless communication in infrastructure-limited environments and address the technical challenges associated with long-range, low-power, multi-device communications.

### SUMMARY

In at least some embodiments, a technically improved method may include the following steps, which may be performed by a processor (such as the processor shown in FIG. 1B): iteratively operating, by at least one processor of at least one first communication device having a long-range (LoRa) low-power radio transceiver with a selectable physical-layer transmission parameter, the at least one first communication device as a node in an ad-hoc mesh network; iteratively maintaining, by the processor, in at least one memory, at least one routing table associating at least one destination identifier respectively with at least one next-hop neighbor identifier and at least one path cost metric; iteratively receiving, by the processor, via the LoRa low-power radio transceiver from at least one neighbor node, at least one routing update packet conveying route advertisements, where each routing update packet may be associated respectively with at least one link metric for a link between the at least one first communication device and the corresponding neighbor node, and where the at least one link metric may be based on at least one transmission time corresponding to at least one selectable physical-layer transmission parameter used for the link; iteratively computing, by the processor, from the at least one routing update packet, the at least one path cost metric as a function of at least one aggregate transmission time for multi-hop delivery; iteratively forwarding, by the processor, based on the at least one routing table, at least one data packet toward the at least one destination identifier via a selected next-hop neighbor identifier having a comparatively lower computed path cost metric; and iteratively transmitting, by the processor, the at least one routing update packet on at least one shared channel using a plurality of different spreading factors in a non-deterministic order, where respective transmission frequencies for the plurality of different spreading factors may be based on respective transmission times of the plurality of different spreading factors, thereby distributing routing information while limiting channel occupancy and reducing persistent collisions.

In at least some embodiments, a technically improved system may include at least one first communication device comprising at least one processor, at least one memory, and a long-range (LoRa) low-power radio transceiver with a selectable physical-layer transmission parameter, where the processor may be configured to iteratively operate the at least one first communication device as a node in an ad-hoc mesh network; iteratively maintain, in the at least one memory, at least one routing table associating at least one destination identifier respectively with at least one next-hop neighbor identifier and at least one path cost metric; iteratively receive, via the LoRa low-power radio transceiver from at least one neighbor node, at least one routing update packet conveying route advertisements, where each routing update packet may be associated respectively with at least one link metric for a link between the at least one first communication device and the corresponding neighbor node, and where the at least one link metric may be based on at least one transmission time corresponding to at least one selectable physical-layer transmission parameter used for the link; iteratively compute, from the at least one routing update packet, the at least one path cost metric as a function of at least one aggregate transmission time for multi-hop delivery; iteratively forward, based on the at least one routing table, at least one data packet toward the at least one destination identifier via a selected next-hop neighbor identifier having a comparatively lower computed path cost metric; and iteratively transmit the at least one routing update packet on at least one shared channel using a plurality of different spreading factors in a non-deterministic order, where respective transmission frequencies for the plurality of different spreading factors may be based on respective transmission times of the plurality of different spreading factors, thereby distributing routing information while limiting channel occupancy and reducing persistent collisions.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1A is a schematic diagram illustrating a system for managing communication devices in an ad-hoc communication network in accordance with one or more embodiments of the present disclosure;

FIG. 1B is a schematic diagram illustrating a system for managing communication devices in an ad-hoc communication network in accordance with one or more embodiments of the present disclosure;

FIG. 2 is a table summarizing recommended channel settings for typical usage scenarios in accordance with one or more embodiments of the present disclosure;

FIG. 3 is a flowchart showing a method for an unregistered device (Du) requesting to register to communicate in the ad-hoc network in accordance with one or more embodiments of the present disclosure;

FIG. 4 is a flowchart showing a method for a registered device (Dn) processing a request from an unregistered device to register to communicate in the ad-hoc network in accordance with one or more embodiments of the present disclosure;

FIG. 5 is a diagram showing the LoRa-based radio system architecture in accordance with one or more embodiments of the present disclosure;

FIG. 6 is a block diagram showing the nodes in a decentralized mesh communicating with a mesh gateway bridging into external IP networks in accordance with one or more embodiments of the present disclosure;

FIG. 7 is a flowchart showing the high-level steps each LoRa-based device to transmit and receive data leveraging multi-hop mesh routing in accordance with one or more embodiments of the present disclosure;

FIG. 8 is a flowchart showing the steps that a registered device Dn may perform to deregister from the network in accordance with one or more embodiments of the present disclosure;

FIG. 9 is a flowchart showing the steps when a registered device goes out of range from any of the connected registered devices on the ad-hoc network in accordance with one or more embodiments of the present disclosure;

FIG. 10 shows steps performed by each of the LoRa-based radio devices implementing publish-subscribe messaging across the ad-hoc network in accordance with one or more embodiments of the present disclosure; and

FIG. 11 is a flowchart of a method for managing communication devices in an ad-hoc communication network in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

Modern communication technologies have become integral to our daily lives, enabling mobile phones, computers, and smart home devices to connect us across distances. However, today's smartphones rely heavily on telecommunication infrastructures like Wi-Fi and cellular networks (3G, 4G, 5G) that may not always be available. In remote areas, disaster zones, or places with limited infrastructure due to low population density or economic constraints, these networks may be unreliable, expensive, or nonexistent. Thus, this leaves many people without affordable access to communication. While some infrastructure-independent technologies exist, they may be inaccessible to many average users due to regulations, high costs, and/or technical complexity. To empower broader populations with low-cost, decentralized communication abilities, these technologies must be integrated into familiar, easy-to-use devices.

At least some embodiments of the present disclosure herein solve this technical problem by using reliable infrastructure-less communication and off-grid decentralized networks. Wireless mesh networks may provide wide area coverage without dependence on dedicated access points. The plurality of LoRa radios may leverage long range (LoRa) communication protocols at the physical layer. Furthermore, a plurality of LoRa-based radios may be well-suited for areas lacking communication towers and/or internet connectivity. Each node in the mesh may see neighboring nodes within range, enabling text messaging at any time. The plurality of LoRa-based radios may self-organize into a mesh topology where data packets may be forwarded multi-hop between nodes. Finally, the plurality of LoRa-based radios may follow a publish-subscribe model for efficient data dissemination.

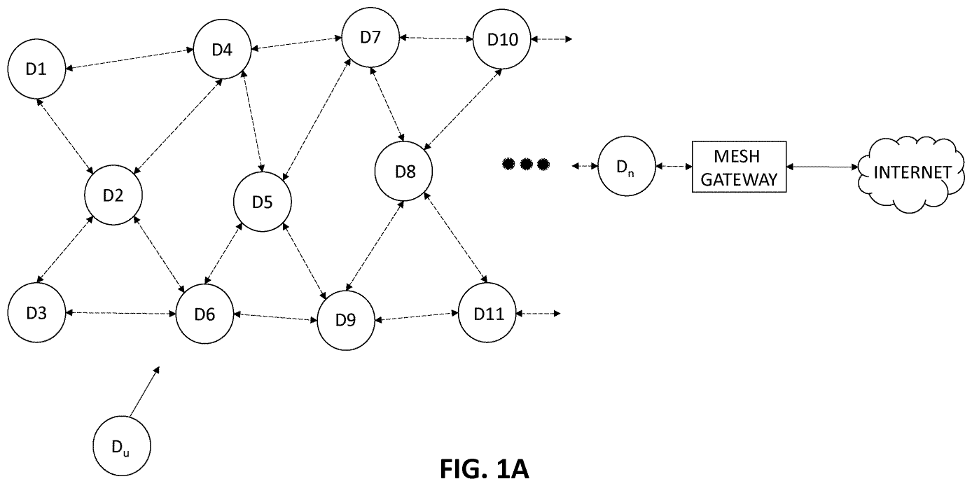

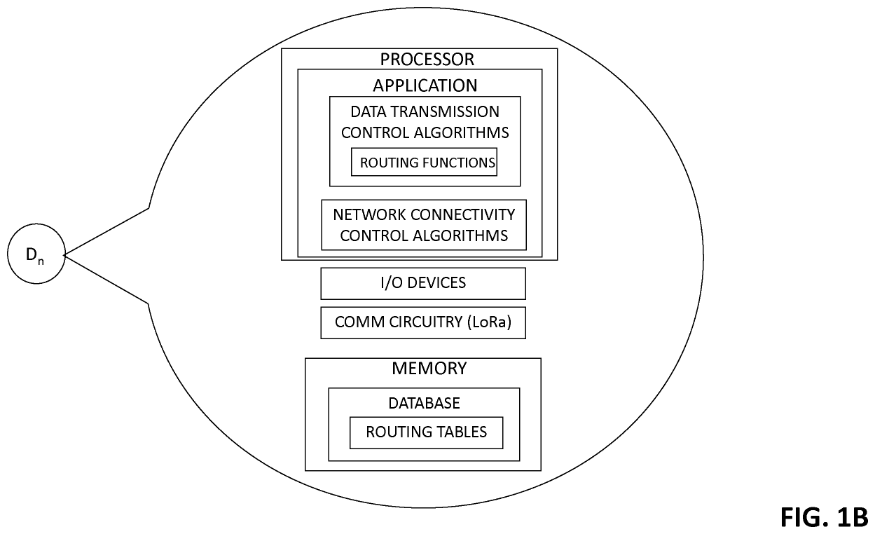

FIGS. 1A and 1B are schematic diagrams illustrating a system for managing communication devices in an ad-hoc communication network in accordance with one or more embodiments of the present disclosure. The system may include a plurality of n communication devices denoted D1, D2, . . . Dn registered to communicate with each other over an ad-hoc mesh network (see dashed lines between elements in FIG. 1A) and a mesh gateway that is configured to relay data between the internet and any of the plurality of n communication devices. The system may also include at least one unregistered device denoted Du that is requesting to communicate over the ad-hoc mesh network.

Note that the plurality of n communication devices may also be referred to herein as a plurality of nodes or a plurality of LoRa-based radios of a LoRa-based radio system.

In at least some embodiments, a LoRa-based radio may include a mobile communication devices, a mobile station, a mobile terminal device, a desktop computing device, a handheld communication device, an integrated, onboard hardware that may be embedded into a circuit board and/or a motherboard, a wearable device, user equipment and the like, all of which are configured in part to communicate using a LoRa communication protocol, as well as any other suitable communication protocols.

In at least some embodiments, the ad-hoc communication network may include communication links established using a LoRa communication protocol, a Bluetooth Low Energy (BLE) communication protocol, a Wi-Fi Direct communication protocol, or any suitable combination thereof. A communication device may include a smartphone, a tablet, an Internet of Things (IoT) device, a wearable device, a beacon device, or any other mobile or portable computing device configured to execute the networking application. In at least some embodiments, the networking application may cause each communication device to establish direct peer-to-peer links with nearby communication devices using BLE, Wi-Fi Direct, LoRa, or any combination thereof, where the communication device may selectively use one or more of such communication links based on availability, range, power consumption, bandwidth, latency, and/or link quality.

In at least some embodiments, the networking application may cause the communication device to dynamically select between multiple available radio interfaces for discovery, connection establishment, packet forwarding, and/or route maintenance. For example, BLE may be used for proximity-based discovery and low-energy control signaling, Wi-Fi Direct may be used for higher-throughput peer-to-peer data exchange, and LoRa may be used for long-range low-power communication across larger geographic areas. In at least some embodiments, a packet may be received over a first communication protocol and may be forwarded over a second communication protocol, where intermediate communication devices may bridge between heterogeneous radio links while maintaining the ad-hoc mesh topology.

FIG. 1B illustrates that each of the plurality of n communication devices denoted Dn and the unregistered device denoted Du may include at least one processor, at least one memory, at least one input and/or output (I/O) device such as, for example, a touchscreen, and at least one communication circuitry configured to communicate over the ad-hoc network using any suitable communication protocol such as LoRa. The at least one processor may be configured to execute at least one software module such as at least one application that may further include data transmission control algorithms based on routing protocols and/or network connectivity control algorithms to be discussed hereinbelow. The at least one memory may store at least one database that may store, for example, routing tables to be discussed hereinbelow.

In at least some embodiments, messages passing between the LoRa-based radio devices and applications may take place via Google Protocol Buffers, providing a platform-neutral structured data format. In essence, LoRa-based radio system described here may combine the long-range communication capabilities of LoRa with multi-hop mesh networking and a development framework to create an infrastructure-less decentralized communication system optimized for remote off-grid environments. Thus, the ad-hoc networks disclosed herein may offer advantages like flexibility, low cost, and robustness. However, wireless mesh network design may be challenging due to issues like noisy channels, limited range, insecure wireless transmissions, node mobility, and energy constraints.

In at least some embodiments, data transmitted through the ad-hoc communication network may include encrypted payload data. A sending communication device may encrypt at least one message payload using a symmetric encryption algorithm, such as Advanced Encryption Standard (AES), and may further protect a session key and/or a message key using a public-key encryption algorithm, such as Rivest-Shamir-Adleman (RSA), associated with an intended recipient communication device. A receiving communication device may use a private key associated with the receiving communication device to recover the protected key material and may decrypt the encrypted payload, where the message content may remain unreadable to intermediate relay communication devices that forward the encrypted payload through the ad-hoc communication network.

In at least some embodiments, the communication devices may implement forward secrecy for at least some communication sessions. A first communication device and a second communication device may perform a key exchange procedure using ephemeral Diffie-Hellman key material to derive at least one shared session key, where newly generated key pairs may be used for a communication session and may not be reused for later sessions. In at least some embodiments, compromise of a long-term key associated with a communication device may not permit retroactive decryption of payload data encrypted using prior ephemeral session keys.

In at least some embodiments, LoRa-based radio system may develop a highly versatile mesh network ecosystem using LoRa's sub-GHz ISM frequencies. Initial applications may be focused on aviation and GPS communications for paragliding, hiking, and skiing where long range links are beneficial. Additionally, the LoRa-based radio system may facilitate applications in disaster management and agriculture. The long-range infrastructure-less mesh networking capabilities may be well-aligned to monitor environmental conditions across extensive geographical areas. LoRa's characteristics of low power operation, kilometers of range, and robustness may provide for wireless sensor networks in remote locations and/or temporary deployments without existing infrastructure.

In at least some embodiments, by harnessing LoRa in a decentralized peer-to-peer mesh topology, the LoRa-based radio system described herein may provide a platform for low cost, rapidly deployable, and adaptable connectivity in a variety of use cases requiring wireless infrastructure-less communications over wide areas. The synergy between LoRa and multi-hop mesh networking may also create new possibilities for remote monitoring and collaborative applications not practical with legacy technologies. For example, in a disaster response scenario where residents use the LoRa-based radio system devices with GPS tracking in their homes and workplaces, these low-power mesh-networked devices may be used to send status updates and/or short messages to emergency services and/or relatives. Gateways may be spread across a city that may receive the messages and/or GPS coordinates and may forward them to response coordination teams.

In at least some embodiments, adverse conditions may isolate beacons and/or render them inoperative. In such cases, the end nodes themselves may be used to take on an active networking role to route packets on behalf of nodes that may have lost infrastructure connectivity. Their embedded GPS capability may allow incident responders to still locate survivors who send messages via multi-hop relaying between end devices to reach operational gateways or other network entry points.

In at least some embodiments, by combining long-range LoRa communication, multi-hop mesh networking, and GPS tracking, the LoRa-based radio system architecture described herein may provide a resilient decentralized solution to maintain situational awareness and/or locate survivors during disasters and/or infrastructure failures. The mesh networking may allow real-time status updates via message relaying around non-functional gateways while GPS enables localization of messaging nodes that may be out of direct gateway range but still reachable via peer-to-peer links.

In at least some embodiments, the ad-hoc communication network may support offline location sharing between communication devices. A communication device may periodically generate at least one location beacon including geographic location data, timestamp data, device identification data, status data, or any combination thereof. Nearby communication devices may receive and relay the location beacon through one or more intermediate communication devices in the mesh, where the relayed location information may facilitate user coordination, device tracking, emergency response, and/or situational awareness in areas having limited or unavailable infrastructure.

In at least some embodiments, location beacons and/or other status data may be buffered at one or more communication devices and may be forwarded when a gateway, bridge node, or other external connectivity point becomes available. A communication device that temporarily lacks a path to a gateway may locally store at least one encrypted location beacon, message, and/or telemetry packet and may later forward the stored data upon restoration of connectivity. In at least some embodiments, such deferred forwarding may facilitate synchronization of mesh-network data with external systems while preserving operation during infrastructure outages.

In at least some embodiments, collecting metering data in the field may be currently a slow, labor-intensive, and costly process. While many cities worldwide may have deployed wireless and/or power line communications for utility meter reading, the LoRa-based radio system described herein may facilitate digitization in underserved areas. By embedding the LoRa-based radio transceivers into metering devices, data may be wirelessly transmitted to collection points. Moreover, mesh networking approaches may be adopted instead of relying solely on gateways. Nodes may relay messages in multi-hop fashion until reaching a data sink, enabling more flexible deployments. This may be especially useful where low node density makes dedicated gateways economically impractical.

In at least some embodiments, consider a water quality monitoring system across a vast, remote mountainous region. Currently, manual readings may be taken at scattered settlements and farms, which may be time-consuming given the lack of telecom infrastructure. While automation may improve efficiency, linking these dispersed devices may require a communication system that may report data over long distances. The number of gateways needed for Long Range Wide Area Network (LoRaWAN) coverage may be prohibitively high, thus rendering LoRaWAN impractical. However, since most nodes may have line-of-sight communication with other nodes, a multi-hop mesh approach through the LoRa-based radio system described herein may be employed instead, forwarding packets between settlements until reaching management facilities.

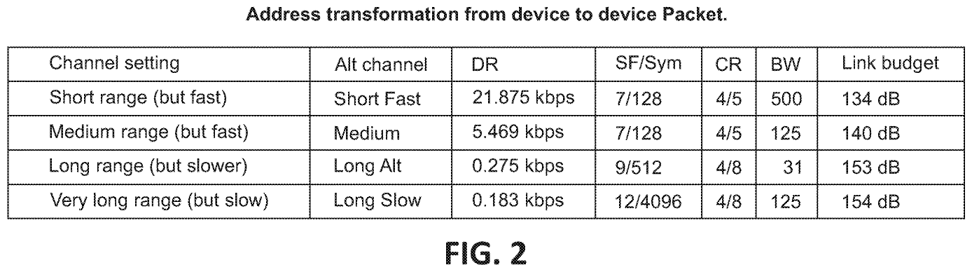

FIG. 2 is a table summarizing recommended channel settings for typical usage scenarios in accordance with one or more embodiments of the present disclosure. The LoRa-based radio system described herein may enable a formation of ad-hoc mesh networks by adding devices on a chosen channel. Different channels may be configured based on the requirements of range, mobility, power consumption, and/or link reliability in a given environment. The flexibility of the software defined LoRa radio system may allow the channel frequency, data rate, and/or link parameters to be adapted as needed for the deployment setting. This may allow optimized performance across diverse use cases from dense indoor monitoring to long range rural applications. The multi-hop mesh networking may provide seamless connectivity even as nodes move out of direct radio range. The LoRa-based radio system advanced configuration options may make it a versatile platform for infrastructure-less ad hoc networking in a wide variety of IoT applications.

In at least some embodiments, in the LoRa-based radio system network described herein, messages may be transmitted as either unicast or broadcast. Unicast may use a 48-byte MAC address to identify an intended recipient device. For broadcast, an address 0xffffffff may be used, for example, but not by way of limitation, to reach all devices on the channel. Alternatively, a custom device name may be specified when sending a message to simplify addressing.

In at least some embodiments, the LoRa-based radio system network described herein may support interoperable communication across devices from different vendors via Protocol Buffers in the API layer. Before each packet transmission, channel parameters like spreading factor, bandwidth, and/or coding rate may be adjusted dynamically based on the link conditions. Devices may synchronize their timestamps using a “settime” command for coordinated experiments. Each data packet in the peer-to-peer protocol as described herein may start with a 32-bit LoRa preamble followed by a 16-byte packet header. A minimum 8-bit preamble may be used to maximize the time that LoRa receivers may remain in a sleep mode, thus dramatically reducing power consumption.

In at least some embodiments, the 16-byte header may follow a specific binary format defined in the C++ source PacketHeader class which may align with the initial bytes of a protobuf schema. A protobuf schema may be a blueprint that may define a structure of data in Protocol Buffers for indicating how programs may interpret and handle data. The header may be transmitted as raw bytes rather than protobuf-encoded to optimize airtime efficiency and allow receiver hardware to filter packets without waking the main CPU.

In at least some embodiments, the LoRa-based radio system network described herein may combine a flexible LoRa physical layer with an efficient binary header format and protobuf-powered API layer to balance long range, low power operation with interoperability across vendors. The adaptive data rates may maximize channel utilization while the sleep-oriented preambles optimize power savings for battery-powered mesh nodes. To evaluate multi-hop LoRa mesh networking, a lightweight proactive hybrid Layer 2/3 distance vector routing protocol was implemented that was optimized for LoRa's characteristics.

In at least some embodiments, key features of the routing protocol may include:
Distance vector—nodes calculate best routes in a distributed fashion based on neighbor info.
Proactive—periodic route broadcasts independently of data traffic keep routing tables up-to-date.
Layers 2+3 hybrid—combines both layers to simplify architecture and reduce needs for low-power LoRa devices.
Duty cycle aware—can adapt for time-on-air restrictions of unlicensed bands.
Lightweight, configurable—fine-tunable metrics, timers, etc. to fit different use cases.
Concurrent networks—LoRa spreading factor orthogonality allows parallel “virtual” networks on one channel.
Multi-SF ToA metric—route costs based on end-to-end transmission time, leveraging multi-SF capability.

In at least some embodiments, the routing protocol may exploit LoRa's capabilities to provide flexible, concurrent multi-hop networking on simple LoRa motes. Proactive control traffic keeps routing updated while multi-spreading factor (SF) transmissions boost throughput. The configurable duties cycle-aware metric balances performance and regulatory compliance. This demonstrates feasible real-world L2/L3 routing tailored for LoRa mesh networks.

In at least some embodiments, the routing protocol may build a flat mesh topology with no hierarchical differentiation between nodes, regardless of their hardware or application role. Each node may run an instance of the protocol, may maintain a local routing table, and may exchange routes periodically with neighbors.

In at least some embodiments, direct one-hop links between pairs of nodes may use the fastest spreading factor that enables connectivity. Multi-hop forwarding over multiple links may leverage the computed routes to reach non-neighbor destinations. While most links are symmetric, asymmetric routes may arise temporarily or persistently due to heterogeneous conditions. This may lead to different forwarding paths for each direction between a node pair.

In at least some embodiments, to simplify the design and application development, OSI Layer 2 and Layer 3 may be merged into one integrated layer, unlike the separation in WiFi/IP stacks. This may reduce overhead and computing needs, although it may limit interoperability with other networks. Addresses are 2 bytes (0x0000-0xFFFF), allowing for over 65,000 addresses per network-a useful scale for LoRa throughput and range. This may be adjusted for specific deployments.

In at least some embodiments, the routing protocol may support unicast to a node's unique address and broadcast to one-hop neighbors using the reserved 0xFFFF address. Acknowledgments, retransmissions, and/or end-to-end guarantees may be omitted for simplicity and small code footprint for leveraging LoRa's capabilities.

In at least some embodiments, the unified L2/L3 approach, flat topology and/or simple broadcast/unicast forwarding may provide a lightweight routing framework well-suited for basic route discovery and maintenance in LoRa mesh networks. The multi-SF aware design may exploit LoRa physical layer flexibility while the lack of reliability mechanisms avoids unnecessary complexity.

In at least some embodiments, data and routing packets may share a similar minimalist structure constrained to LoRa's 256 byte maximum. Data packets may include up to 7 bytes overhead as follows:
Source (2 bytes): Originating node address.
Destination (2 bytes): Final recipient address.
Via (2 bytes): Next hop address, changing at each hop, same as Destination at last hop
Flags (1 byte): Packet tags from application layer (2 bits), Time to live (TTL) counter (6 bits) limiting packets to 64 hops
Payload (up to 249 bytes): Application data

In at least some embodiments, routing packets may omit the Via field to gain 2 extra payload bytes (up to 251 bytes). The broadcast address 0xFFFF may identify routing packets and may indicate flooding to all neighbors.

In at least some embodiments, each node may be configured to run the routing protocol instance and to build a local routing table, that may be constantly updated as new data arrives. This distributed distance vector table may list all known destinations, next hops, costs, and/or expiry times. Nodes may communicate directly with neighbors or multi-hop via optimal forwarding paths. Nodes may also track inbound routes from neighbors since links may be asymmetric. Feedback on inbound costs ensures neighbors route correctly.

In at least some embodiments, data and routing packets may share a compact format adapted for LoRa's constraints. Omitting unnecessary fields may reduce overhead while allowing larger payloads. The routing table may store up-to-date network topology information to enable optimal multi-hop packet forwarding. Bidirectional cost tracking may handle potential asymmetric links.

In at least some embodiments, when a node may receive a new routing packet, it may process the information to update its local routing table:
1. The link characteristics with the source neighbor may be added or refreshed.
2. Each route announcement may be handled as follows:
   New routes may be added to the table.
   Known routes may be updated if changes are detected.
   Existing routes may be replaced if a better path is found.
   Useless routes may be discarded.

In at least some embodiments, this update procedure described above may ensure that the routing table dynamically adapts as new information propagates across the network. Routes may improve over time as better paths are learned, while outdated or redundant routes are removed. The end result may be an accurate global network view at each node enabling efficient multi-hop forwarding. The routing protocol's proactive approach may maintain optimal paths even as link costs fluctuate, or nodes join/leave the network.

In at least some embodiments, nodes running the routing protocol may periodically broadcast packets to neighboring nodes. This may proactively propagate topology information and maintains up-to-date routing tables:
Packet source address may identify the originating node.
A counter may track packet loss instead of TTL to infer link quality.
Node's routing table excerpt may provide its current best routes and/or costs.

In at least some embodiments, neighbors receiving the broadcast may update their tables accordingly and may further propagate the routes in their own broadcasts. This flooding process may disseminate routes network-wide.

In at least some embodiments, nodes may have single-channel radios using the described multi-SF reception technique, allowing transmission/reception at any SF from SFmin to SFmax. The routing protocol may use:
Single-SF metrics-One network-wide SF.
Multi-SF metrics-Dynamic SF switching per node conditions.

In at least some embodiments, since higher SFs may take twice (2×) transmission time, multi-SF broadcast behavior is:
Packets sent 2× faster at lower SFs to equalize costs.
Random transmission order across SFs (not sequential).

This ensures faster links may get more frequent updates while balancing airtime across SFs. The result may be efficient network-wide route distribution leveraging the LoRa-based radio multi-SF capabilities. Broadcast packets on different SFs may be sent in random order (rather than sequentially), using the following probability formula:

The routing protocol's random transmission order across spreading factors may also help avoid

$$p ( {SF}_{n} ) = \frac{{2}^{{SF}_{max} - {SF}_{n}}}{{\sum }_{i = min}^{max} {2}^{{SF}_{i} - {SF}_{min}}}$$

$$since :$$

$${\sum }_{i = min}^{max} p ( {SF}_{i} ) = 1$$

$$p ( {SF}_{min} ) = {2}^{{SF}_{max} - {SF}_{min}} \cdot p ( {SF}_{max} )$$

synchronized collisions. If nodes followed a predefined SF sequence for broadcasts, their periodic transmissions may repeatedly collide after becoming synchronized over time. The randomized approach reduces this risk. Nodes may select broadcast SFs independently in a probabilistic manner, resulting in constantly varying uncorrelated transmission patterns that may minimize persistent collisions. This may further improve reliability and robustness in addition to balancing route propagation across SFs.

In at least some embodiments, when routing update packets are transmitted using a plurality of different spreading factors, a communication device may probabilistically select a spreading factor for a given routing transmission based on relative transmission times associated with the plurality of different spreading factors. Lower transmission-time spreading factors may be selected more frequently than higher transmission-time spreading factors so as to balance route dissemination with channel occupancy. In at least some embodiments, the communication device may independently randomize spreading-factor selection for successive routing transmissions, where such randomized probabilistic selection may reduce repeated synchronization between neighboring communication devices and may thereby reduce persistent packet collisions.

In at least some embodiments, routing packets may be single-hop broadcasts similar to data packets, using the reserved 0xFFFF destination address. Their payload may carry route advertisements from the source node. If the full routing table exceeds payload space, routes may be randomly sampled for transmission based on their cost to focus on better paths.

In at least some embodiments, upon receiving a routing packet, nodes may process the routing packet to update their local table:
The link to the source neighbor is added/refreshed.
Each advertised route is added or updated accordingly.

In at least some embodiments, the routing protocol may be configured with different strategies, especially regarding path cost metrics used to select forwarding routes. These strategies may include:
Flooding: Packets broadcast to all neighbors without routing decisions. Nodes cache recent packets to limit amplification.
Single-SF metrics: Like Hop Count or Expected Transmission Count.
Proposed multi-SF Time-on-Air metric.

In at least some embodiments, one approach may be pure flooding where nodes may simply rebroadcast packets without routing. In other embodiments, a more advanced version may track neighbors and unicasts to the final hop, but may still lacks path optimization.

In at least some embodiments, true routing strategies may calculate costs to neighboring nodes and may make forwarding decisions to optimize metrics like latency or reliability. Multi-SF time-on-air metric may tune routing specifically for the LoRa-based mesh networks described herein.

In at least some embodiments, the routing logic may use context information in addition to link cost information when selecting a forwarding path. Such context information may include current device location, device role, battery level, congestion state, mobility state, hotspot availability, beacon availability, gateway reachability, message type, message priority, or any combination thereof. A communication device may update one or more routing decisions based on such context information to improve message delivery reliability, power efficiency, latency, and/or coverage under dynamic operating conditions.

In at least some embodiments, for single-SF LoRa-based networks, our routing protocol may implement four path cost metrics:
1. Hop Count (HC)—Cost equal to number of hops to destination.
2. Expected Transmission Count (ETX)—Cost depends on a quality of links along a path, proportional to transmissions required end-to-end. Link quality may be measured by counting lost routing packets over time (more losses may mean higher link cost).
3. Minimum Delay (MD)—Cost based on transmission and propagation delay of each link. The approach favors lower latency paths.
4. Maximum Data Rate (MDR)—Cost may depend on data rate of each link, preferring routes with highest end-to-end data rate.

In at least some embodiments, the HC cost metric may provide a basic routing capability but may lack awareness of link performance. The ETX cost metric may improve upon the HC cost metric by incorporating packet loss to prefer reliable, high-quality paths. The MD cost metric may tune for latency by accounting for per-hop delays. The MDR cost metric may maximize throughput by selecting routes with best data rates. This range of single-SF metrics may allow tuning routing strategy based on the most important factors for a given deployment, whether reliability, latency, and/or throughput. Their implementations may validate feasible routing tailored for LoRa networks.

In at least some embodiments, the spreading factor may be a key parameter in LoRa, representing a tradeoff between range and transmission time. Higher SFs may approximately double the on-air time (halving the data rate) while increasing range by 25-40%. Transmission time may also directly impact energy consumption, which may be critical for battery powered LoRa devices common in LPWAN IoT deployments. As such, both channel occupancy and power may be scarce resources.

In at least some embodiments, the spreading factor may include a selectable physical-layer transmission parameter of a LoRa low-power radio transceiver, where the spreading factor may affect transmission time, time-on-air, data rate, communication range, channel occupancy, and energy consumption for a given wireless transmission. A higher spreading factor may be associated with a longer transmission time and a lower data rate, and may also provide increased communication range and robustness under some link conditions. A lower spreading factor may be associated with a shorter transmission time and a higher data rate, and may reduce channel occupancy and power usage for a given packet. A communication device may select the spreading factor for a transmission based on link conditions, destination, neighboring node characteristics, route-selection considerations, or other operating conditions, where the selected spreading factor may be used in determining a link metric and may further be used in computing a path cost for multi-hop delivery through the ad-hoc mesh network.

In at least some embodiments, considering these restrictions, a Time-on-Air (ToA) routing metric may be used to minimize the end-to-end transmission time and channel usage when sending a packet from source to destination. The ToA metric may calculate path cost metrics based on the spreading factors of each successive link along the route to the destination node. Unlike single-SF metrics, ToA may leverage LoRa's capability to use different SFs dynamically on a per-link basis. This may allow identifying the combination of SFs that may provide the fastest route in terms of total transmission time. By optimizing for lower ToA, the routing protocol may minimize both channel occupancy as well as energy expenditure in the battery-constrained mesh nodes. The ToA metric exemplifies a routing strategy customized for the characteristics and constraints of LoRa-based LPWANs.

In at least some embodiments, the routing protocol may employ several techniques to mitigate routing loops:
For expired direct routes, nodes may advertise maximum cost to trigger rapid drops. However, unreliability may limit effectiveness.
Upon detecting unreachable routes, nodes may temporarily ignore updates to avoid infinite count, which may slow convergence.
Routes may reach a finite maximum cost and may be discarded, eventually breaking loops, which may limit network scale.
Data packets may have a 64-hop limit. Lower TTLs speed loop may be discarded but may reduce reach.
   The combination of these mechanisms may aim to balance fast loop resolution, network stability, and scalability:
Poisoned reverse quickly triggers re-convergence but may not be 100% reliable.
Temporary hold-downs may prevent count oscillations at the cost of responsiveness.
Cost thresholds may break loops at the expense of possible path lengths.
Adaptive TTLs may discard looping packets faster yet bound topology size.
   Overall, these configurable techniques may allow managing the tradeoffs between loop prevention, network scale, and/or convergence speeds. Further enhancements like duplicate poisoned messages may strengthen reliability. The layered approach may demonstrate feasible, practical routing loop mitigation that may be tailored for LoRa mesh networks.

In at least some embodiments, multi-SF routing strategies such as the Time-on-Air metric, for example, may positively impact packet delivery ratio, a key indicator of scalability in heterogeneous networks. By adapting to diverse link conditions, multi-SF routing may handle topology irregularities better than single-SF approaches, thus improving overall performance. However, for very uniform grids, multi-SF provides no real advantage. Since real-world deployments may likely experience diversity in node locations and environmental conditions (e.g., attenuation, interference, and/or neighbor counts), the flexibility of multi-SF routing may ease deployment and enhance reliability. At the least, it may improve end-to-end packet delivery over single-SF routing in non-ideal topologies.

In at least some embodiments, as the LoRa-based mesh networks described herein scale up in terms of size, density, and/or variability, multi-SF routing may become more beneficial compared to single-SF by accounting for diverse link characteristics. The ToA metric may demonstrate the potential of multi-SF-aware routing to handle complexity and boost performance in large, heterogeneous LoRa-based networks.

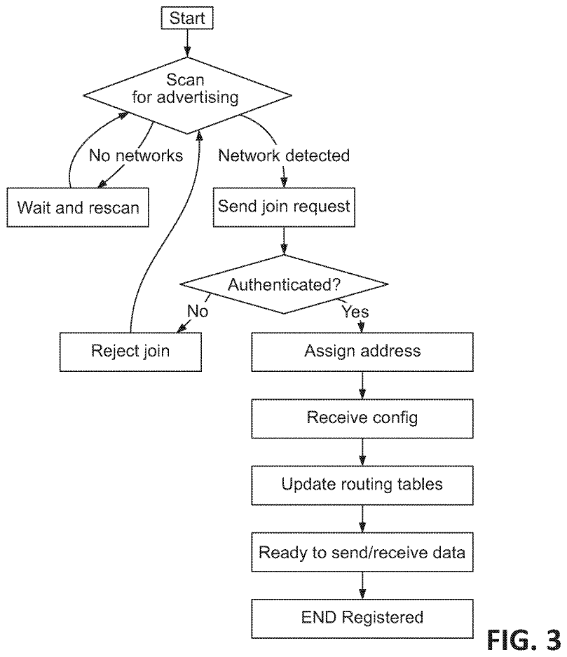

FIG. 3 is a flowchart showing a method for an unregistered device (Du) requesting to register to communicate in the ad-hoc network in accordance with one or more processors of the present disclosure. The processor of the unregistered device Du may execute the following steps as shown in the FIG. 3 flowchart:
1. The unregistered device scans all channels listening for any LoRa network advertisements. This would be from nodes already part of a LoRa mesh emitting periodic beacons.
2. If no mesh advertisements are received after scanning all channels, the device waits and repeats scanning until it detects a network.
3. Once a LoRa mesh is detected, the device may transmit a join request packet to any node already inside the network. This packet may signal the device's intention to join.
4. The receiving node may verify the authenticity of the join request. This may involve cryptographic validation of credentials or other custom access control logic.
5. If the join request authentication fails, the node may reject the new device. The device may then repeat scanning for networks.
6. Upon successful authentication, the node may assign a valid address to the new device and may send necessary configuration info.
7. The new device may update its parameters and routing tables to join the mesh topology.
8. After fully registering, the new device may now send and receive packets over the LoRa mesh to other nodes.

In at least some embodiments, a hotspot-enabled communication device may further act as a distribution point for software associated with the networking application. A communication device that does not currently include the networking application may connect to the hotspot-enabled communication device and may receive installation data, configuration data, update data, onboarding data, or any combination thereof. In at least some embodiments, such hotspot-based onboarding may facilitate expansion of the ad-hoc communication network by enabling nearby devices to obtain the networking application and join the mesh using local peer-to-peer connectivity rather than relying on external infrastructure.

In at least some embodiments, a system may include a plurality of registered communication devices (e.g., forming a plurality of LoRa-based nodes) that may be registered to communicate with each other over a long range (LoRa) mesh communication network using a LoRa protocol defining a plurality of LoRa communication channels, and at least one unregistered communication device that may include at least one memory and at least one processor. The at least one processor may be configured to execute a software application that may facilitate LoRa communication and may cause the at least one processor to: continuously scan the plurality of LoRa communication channels to detect at least one emitted LoRa advertisement beacon emitted from at least one registered communication devices from the plurality of registered communication devices; transmit, in response to detecting the at least one emitted LoRa advertisement beacon from the at least one registered device, at least one join request data packet requesting to communicate over the LoRa mesh communication network; where the at least one join request data packet may include authentication credentials; perform the continuous scan when the at least one join request data packet is rejected, or receive a joining address, a LoRa communication configuration data, or both, from the at least one registered device indicating that the at least one join request data packet is accepted; and update at least one parameters and routing table in at least one memory of the at least one unregistered communication device so as to convert the at least one unregistered communication device to at least one newly-registered communication device from the plurality of registered communication devices to communicate with any other of the plurality of registered communication devices over the LoRa mesh communication network.

In at least some embodiments, the system may include a mesh gateway configured to relay data with the Internet.

In at least some embodiments, one or more communication devices may be configured to operate in a hotspot mode. A communication device operating in the hotspot mode may act as a relay point for packet forwarding between other communication devices in the ad-hoc communication network, where the hotspot mode may increase connectivity coverage, route redundancy, and/or resiliency. In at least some embodiments, when a direct communication path between a first communication device and a second communication device is unavailable or degraded, at least one hotspot-enabled communication device may relay packets between the first communication device and the second communication device to maintain message delivery.

In at least some embodiments, at least one bridge registered communication device from the plurality of registered communication devices may be configured to relay the data from any of the plurality of registered communication devices with the Internet.

In at least some embodiments, the registered communication devices may be out of range to communicate wirelessly using other communication protocols, such as for example but not limited to cellular, WiFi protocols.

In at least some embodiments, each of the plurality of registered communication devices may include the software application that facilitates LoRa communication. In other embodiments, the software application may run as a background system service in each of the plurality of registered communication devices.

In at least some embodiments, each of the plurality of registered communication devices may include a system on a chip that further includes but is not limited to a microcontroller including the at least one processor, a LoRa transceiver, a Bluetooth communication module, the at least one memory including an SPI Flash memory, and a global positioning system (GPS) communication module.

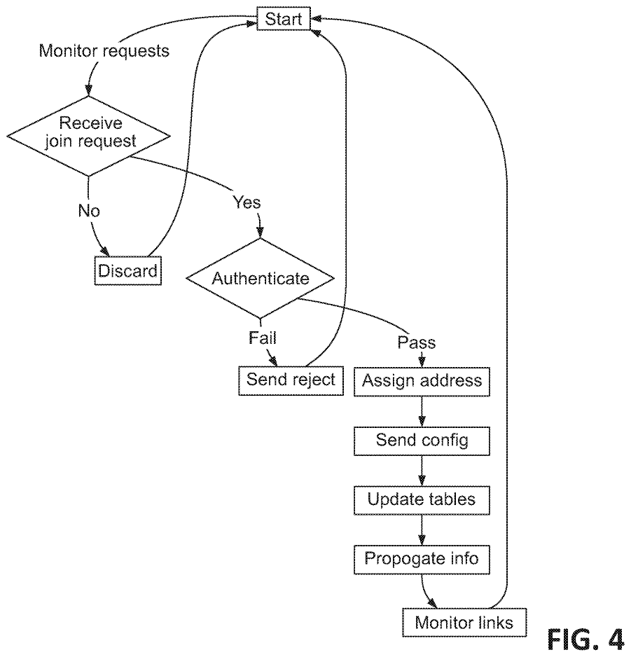

FIG. 4 is a flowchart showing a method for a registered device (Dn) processing a request from an unregistered device to register to communicate in the ad-hoc network in accordance with one or more processors of the present disclosure. The processor of the registered device Dn may execute the following steps as shown in the FIG. 4 flowchart:
1. The registered LoRa node monitors the channels for any join requests sent out by unregistered devices seeking to connect to the ad-hoc mesh network.
2. Upon receiving a join request packet, the node authenticates the request to validate permissions etc. This may use cryptography or access control lists.
3. If authentication fails, the node sends a reject message back to the requester and discards the request.
4. When the credentials/request passes authentication, the node assigns a valid network address to the new device.
5. The node sends necessary configuration info and parameters to the new device.
6. The node updates its own routing tables and shares network topology.
7. It propagates the registration information to other nodes in the mesh (new peer for routing).
8. The node monitors connectivity and traffic from new peer device to ensure it joined properly.

In at least some embodiments, once an unregistered device (Du) successfully joins the LoRa ad-hoc network, it transmits/receives data via optimal multi-hop routing that includes:
1. The newly registered device may receive periodic routing update packets from its direct neighbor nodes. These advertise their routing tables with cost metrics.
2. The device may maintain its own routing table, populated by the routes and costs learned from all neighbor broadcasts. This may be used to build an overall network topology view.
3. To pick optimal paths, the node running the LoRa protocol may calculate end-to-end route costs to every potential destination based on the neighbor advertisements.
4. The cost metric may be used to determine optimality—it may be minimum time-on-air, highest throughput, lowest latency etc. depending on network-wide config.
5. With its dynamically updated routing table, the device may identify the next-hop providing the best route to any given destination based on the path cost function.
6. For sending data, the node may set the “Via” field to the next hop's address. This may be updated at every intermediate hop until reaching the final destination.
7. For receiving data, nodes along the path forward packets may be based on checking the “Via” field against their own routing tables until the packet reaches the final destination address.
8. If link costs change from mobility or congestion, updated routes may propagate network-wide to recalculate least-cost forwarding decisions.

This distributed routing approach may rely on constant route updates and cost metrics to achieve dynamically optimal multi-hop paths based on current network conditions. The configurable cost metric determines specific optimization criteria.

In at least some embodiments, the LoRa-based devices that for enabling peer-to-peer mesh networking may be implemented as “system on a chip” designs (e.g., elements of block diagram of Dn shown in FIG. 1B). The “system on a chip” designs may include:
Microcontroller—ARM Cortex M4 processor for network stack (processor FIG. 1B)
LoRa transceiver—Long range sub-GHz radio for communications (Comm Circuitry)
Bluetooth Low Energy (BLE)—For proximity device discovery (Comm Circuitry FIG. 1B)
Memory—SPI Flash to store firmware and parameters (Memory FIG. 1B)
GPS module—For location tagging of data and tracking (Comm Circuitry FIG. 1B)

In at least some embodiments, the system may include a plurality of deployable beacon hardware units configured to be placed throughout an environment to establish and/or reinforce the ad-hoc communication network. Each deployable beacon hardware unit may include at least one processor, at least one memory, and at least one wireless communication circuitry configured to communicate with mobile communication devices and/or other deployable beacon hardware units. In at least some embodiments, the deployable beacon hardware units and the mobile communication devices may collectively form a self-organizing mesh network that may be rapidly deployed to provide communication coverage across an area.

In at least some embodiments, the ad-hoc communication network may be configured as a rapidly deployable pop-up network. Mobile communication devices, deployable beacon hardware units, gateway devices, or any combination thereof may be activated in a target environment and may automatically discover one another, establish communication links, exchange network configuration data, and form multi-hop communication paths without reliance on preexisting communication infrastructure. In at least some embodiments, the resulting network may be self-configuring, self-healing, and context-aware, where route selection and forwarding behavior may adapt in response to changing device availability, radio conditions, topology changes, message priority, congestion conditions, location information, and/or external connectivity status.

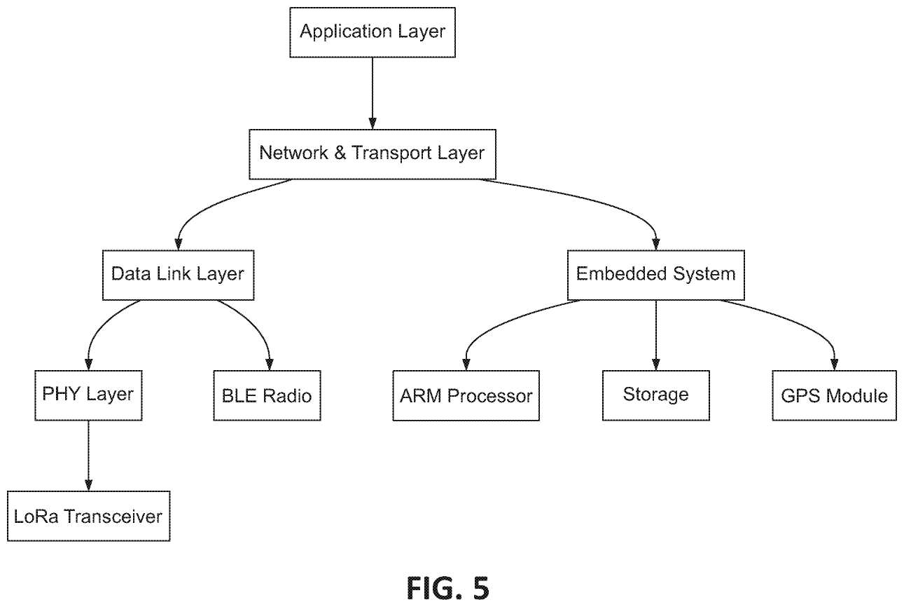

FIG. 5 is a diagram showing the LoRa-based radio system architecture in accordance with one or more embodiments of the present disclosure.

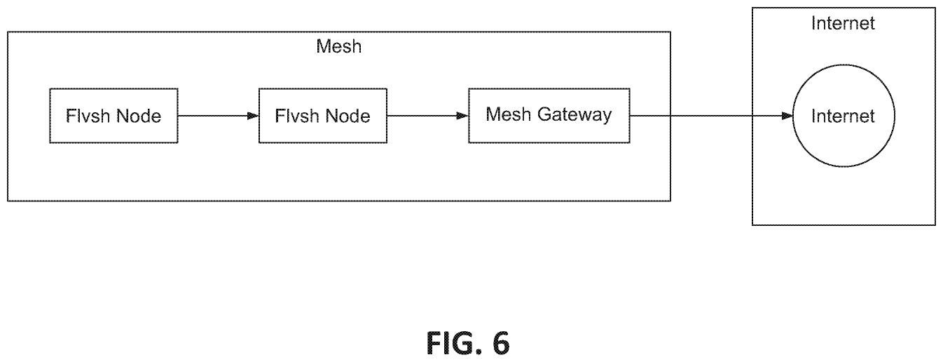

FIG. 6 is a block diagram showing the nodes in a decentralized mesh communicating with a mesh gateway bridging into external IP networks in accordance with one or more embodiments of the present disclosure. The mesh gateways may include the same LoRa radio and WiFi/Ethernet to forward packets externally when needed. But core mesh may allow peer-relaying without infrastructure.

In at least some embodiments, the application shown in FIG. 1B may include the core networking software and routing functions for LoRa capabilities embedded within each participating mobile device (D1, D2 . . . . Dn) in the mesh.

In at least some embodiments, the application may run as a background system service on smartphones and IoT devices that may implement functionality like decentralized neighbor discovery, link establishment, topology maintenance, and packet routing. The application may leverage native OS capabilities like accessing the Bluetooth/WiFi radio for broadcasting, scanning packets, sending messages etc. The application may further provide custom mesh protocols and routing algorithms optimized for mobile ad hoc scenarios atop the radios that may include custom lightweight distance vector routing and time-on-air path cost metrics.

In at least some embodiments, the nodes may gain visibility to overall network insights required for routing by sharing neighbor table extracts peer-to-peer as per the routing protocols. Network intelligence may be fully distributed at the application level rather than centralized.

In at least some embodiments, the plurality of n communication devices may form dynamic end-to-end paths via decentralized coordination between application instances that may effectively serve as autonomic “plug-and-play” networking between participating nodes.

In at least some embodiments, the dedicated mesh networking logic and/or control plane driving the LoRa-based radio system may be packaged as a specialized application leveraging native OS/hardware connectivity. It may equip each LoRa-based device to act as an independent routing node that may collectively coordinate to transport data multi-hop sans infrastructure.

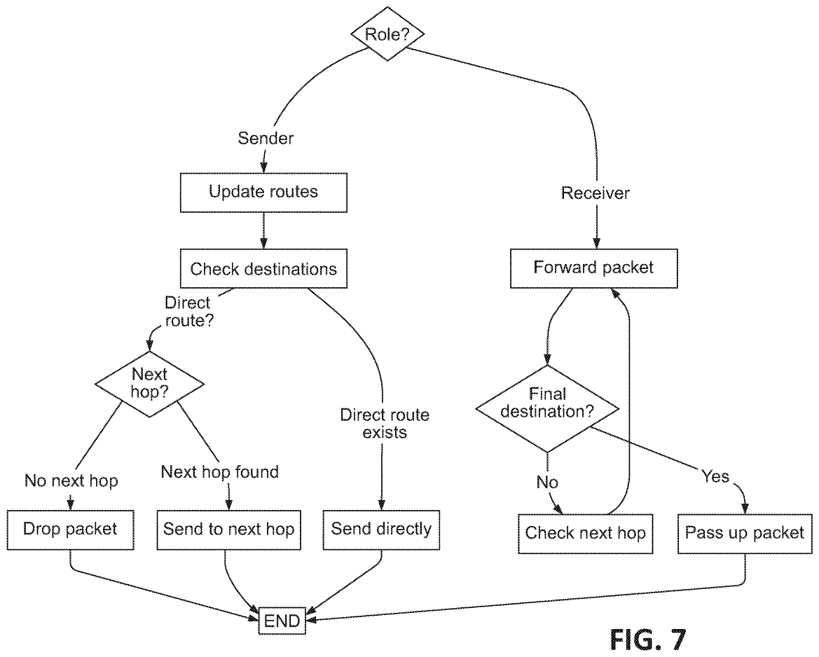

FIG. 7 is a flowchart showing the high-level steps each LoRa-based device to transmit and receive data leveraging multi-hop mesh routing in accordance with one or more embodiments of the present disclosure. The steps for transmitting and receiving data may be performed by the at least one processor of any of the plurality of n communication devices such as:

Steps when Transmitting:
1. Sender node may check routing table for lowest cost next hops to each destination.
2. If no route exists to intended destination, packet may be dropped.
3. If the route is available, node forwards packet to next hop address
4. Process repeats at each intermediate hop until packet reaches final destination
   Steps when Receiving:
1. On receiving a packet, node may check if it is the final destination address
2. If not, it may search the routing table for next hop with lowest cost route to packet's destination
3. Packet may be forwarded to next hop for further relaying
4. Process may continue until packet is delivered to ultimate destination

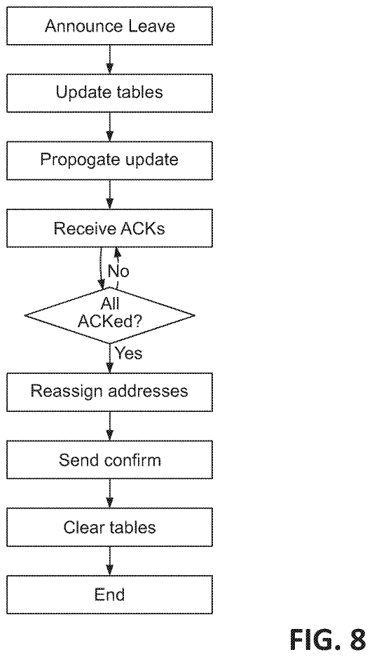

FIG. 8 is a flowchart showing the steps that a registered device Dn may perform to deregister from the network in accordance with one or more embodiments of the present disclosure. The processor of Dn (e.g., the departing device) may perform the voluntary unregistering steps of:
1. The departing device may announces its intention to leave the mesh network by sending special LEAVE packet to neighbors
2. Neighbors may update routing and topology tables marking device as unreachable
3. News of departure may be propagated to the rest of network to recompute paths
4. Original device may wait for ACKs from peers to confirm propagation before taking next actions
5. Once fully acknowledged, the network may reclaim the address assigned to departing device
6. Departing device may clear all internal LoRa networking state/tables
7. The departing device is now cleanly disconnected from the mesh network

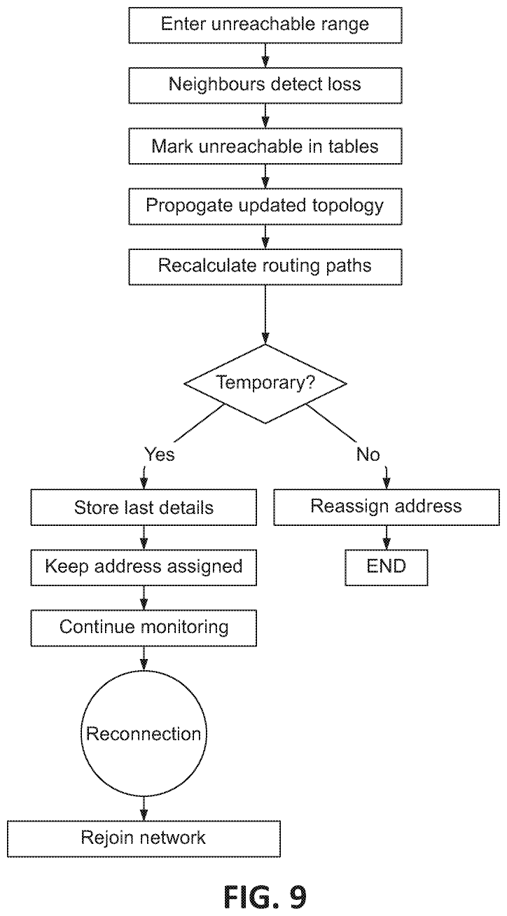

FIG. 9 is a flowchart showing the steps when a registered device goes out of range from any of the connected registered devices on the ad-hoc network in accordance with one or more embodiments of the present disclosure. These steps may be performed by the processors of the neighboring device that are related to an involuntary disconnection of one registered device. These steps may include:
1. Device moves out of any neighbor's radio range, breaking its last mesh link
2. Neighboring nodes may detect loss of connectivity (e.g., via heartbeat timeout)
3. They may flag device as unreachable and update their local topology view
4. This change may be propagated network-wide to update overall routing paths
5. Based on stored details and reconnection expectations, node may either:
   a) Keep device details—to handle temporary/movement based disconnects
   b) Reclaim resources—Assume permanent disconnection
6. For temporary cases, network may keep monitoring and reconnects transparently
7. For permanent disconnects, the disconnected device must fully re-register on return.
   These steps aim to balance reuse of resources while avoiding premature disconnecting of clients. This policy may be tuned based on expected mobility models and tolerance for partitioned operation.

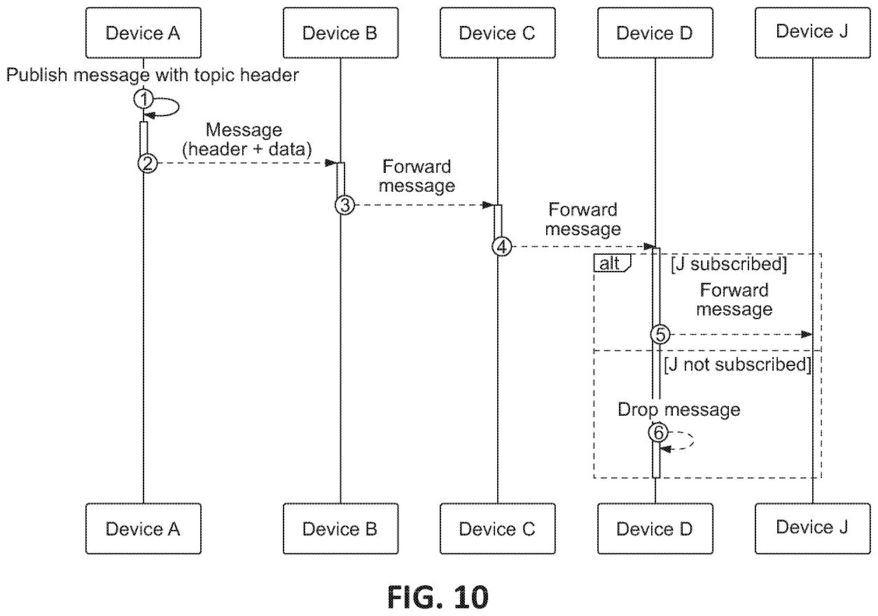

FIG. 10 shows steps performed by each of the LoRa-based radio devices implementing publish-subscribe messaging across the ad-hoc network in accordance with one or more embodiments of the present disclosure. The publish-subscribe model may provide for efficient data transmission. In this paradigm, FIG. 10 illustrates the technical steps performed on cellular device A of transmitting and/or receiving data through the ad-hoc network of 10 mobile devices denoted mobile devices A-J, particularly in view of the reduced size 8-bit preamble.

In at least some embodiments, when Device A publishes:
1. It may set an 8-bit topic ID in the binary message header that devices may subscribe to, indicating the data category
2. It may minimize preamble to maximize receiver sleep time for power savings
3. It may send complete message (header+data payload) to next hop B

In at least some embodiments, the intermediate devices B-D may inspect the header topic ID to determine if recipient has subscribed.
1. If yes, the intermediate devices may forward to next hop based on routing tables
2. If no, drop message to avoid waste transmissions

Hence, the devices may self-filter data not matching their subscribed topics. The publisher may set the taxonomy and subscribers may choose data planes to reduce traffic.

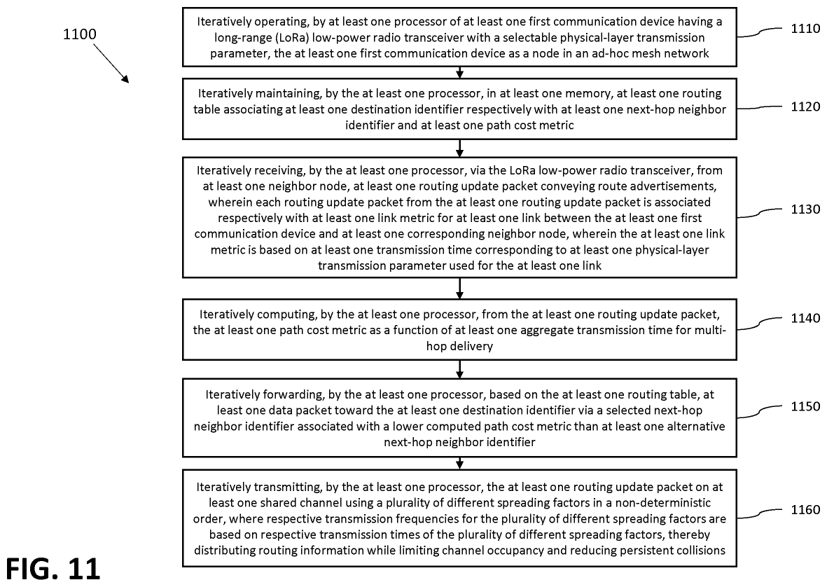

FIG. 11 is a flowchart of method 1100 for managing communication devices in an ad-hoc communication network in accordance with one or more embodiments of the present disclosure. The method may be performed by the processor of FIG. 1B.

In at least some embodiments, the method 1100 may include iteratively operating 1100, by at least one processor of at least one first communication device having a long-range (LoRa) low-power radio transceiver with a selectable physical-layer transmission parameter, the at least one first communication device as a node in an ad-hoc mesh network.

In at least some embodiments, the at least one first communication device may include any suitable user device, mobile device, handheld device, fixed device, beacon device, relay device, gateway-capable device, or other communication-enabled hardware platform configured to participate in peer-to-peer wireless communications. The at least one processor may include one or more microprocessors, controllers, system-on-chip devices, programmable logic devices, or other processing circuitry that may execute stored instructions from at least one memory to control radio operation, routing behavior, packet processing, neighbor discovery, and network participation. The long-range low-power radio transceiver may include a LoRa radio, LoRa-compatible radio, or other chirp spread spectrum radio architecture configured for low-power, long-range wireless communication, and the selectable physical-layer transmission parameter may include a spreading factor, bandwidth, coding rate, transmit power, channel selection, symbol rate, preamble configuration, or any combination thereof.

In at least some embodiments, operating the at least one first communication device as a node in the ad-hoc mesh network may include causing the at least one first communication device to join, establish, maintain, rejoin, and/or otherwise participate in a decentralized multi-node network without requiring continuous reliance on fixed communication infrastructure, where the ad-hoc mesh network may include a plurality of neighboring nodes that may cooperatively relay packets over one or more hops toward intended destinations.

In at least some embodiments, iteratively operating may include repeatedly, periodically, continuously, intermittently, event-drivenly, and/or opportunistically performing node functions over time as network conditions change. For example, the at least one first communication device may repeatedly monitor channel conditions, detect neighboring nodes, exchange routing information, update local network state, transmit packets, receive packets, adjust radio settings, and respond to node mobility, link degradation, congestion, interference, and/or node failure.

In at least some embodiments, the selectable physical-layer transmission parameter may include at least one configurable radio transmission setting of the long-range low-power radio transceiver that may be selected for use in transmitting a packet over a wireless link. The selectable physical-layer transmission parameter may include, for example, a spreading factor, a bandwidth, a coding rate, a transmit power, a channel selection, a symbol rate, a preamble configuration, or any combination thereof. In at least some embodiments, selection of the physical-layer transmission parameter may affect transmission time, time-on-air, link range, packet robustness, channel occupancy, energy consumption, interference behavior, reception reliability, or overall route performance within the ad-hoc mesh network.

In at least some embodiments, the selectable physical-layer transmission parameter may be selected before transmission, per transmission, per packet, per destination, per neighbor node, per link, per route, or according to changing network conditions. For example, different links associated with different neighboring nodes may use different respective physical-layer transmission parameters based on distance, signal quality, packet loss, congestion, interference, topology changes, priority, or other operating conditions. In at least some embodiments, where the selectable physical-layer transmission parameter includes a spreading factor, the spreading factor may be used as a basis for determining transmission time for a link, and the transmission time may be used in computing link metrics and path cost metrics for multi-hop delivery.

In at least some embodiments, this operating functionality may provide an ongoing node-participation state for the at least one first communication device rather than a one-time initialization event, and may establish the technical context for maintaining routing tables, receiving routing update packets, computing path cost metrics, forwarding data packets, and transmitting routing information using different spreading factors.

In at least some embodiments, the method 1100 may include iteratively maintaining 1120, by the at least one processor, in at least one memory, at least one routing table associating at least one destination identifier respectively with at least one next-hop neighbor identifier and at least one path cost metric.

In at least some embodiments, the at least one memory may include any suitable volatile memory, non-volatile memory, cache memory, flash memory, persistent storage, or other machine-readable storage medium accessible to the at least one processor for storing routing information. The at least one routing table may include a local data structure, database, list, map, index, record set, or other stored association that may identify known destinations in the ad-hoc mesh network and may indicate how packets may be forwarded toward those destinations. In at least some embodiments, the at least one destination identifier may include a node address, device identifier, network identifier, logical address, packet destination field value, or other value associated with an intended recipient node, and the at least one next-hop neighbor identifier may include a neighboring-node address or other identifier corresponding to a directly reachable communication device through which forwarding toward the destination may occur. The at least one path cost metric may include a metric representing relative route quality or forwarding suitability and may be based on transmission time, time-on-air, latency, throughput, reliability, packet loss, energy usage, hop count, duty-cycle considerations, or any combination thereof.

In at least some embodiments, iteratively maintaining 1120 may include repeatedly, periodically, continuously, intermittently, or event-drivenly creating, updating, refreshing, replacing, pruning, aging, or otherwise managing entries of the at least one routing table as network information may change over time. For example, the at least one processor may receive routing information from neighbor nodes, may evaluate new routes, may compare newly learned route costs with stored route costs, may select a preferred next hop for a destination, may update expiry information for valid routes, and may remove stale, redundant, or less preferred routes.

In at least some embodiments, the at least one routing table may include destinations, next hops, costs, and/or expiry times so that the at least one first communication device may maintain an updated local view of network topology for direct and multi-hop forwarding. Such maintenance may support a distributed distance-vector routing approach in which each node may independently store and update its own routing information based on neighbor information rather than relying on centralized network infrastructure. In at least some embodiments, maintaining the at least one routing table in this manner may enable the at least one first communication device to adapt to changing link conditions, node mobility, topology changes, node additions, node departures, asymmetric links, congestion conditions, and varying physical-layer transmission settings across different links in the ad-hoc mesh network.

In at least some embodiments, the method 1100 may include iteratively receiving 1130, by the at least one processor, via the LoRa low-power radio transceiver, from at least one neighbor node, at least one routing update packet conveying route advertisements, wherein each routing update packet from the at least one routing update packet is associated respectively with at least one link metric for at least one link between the at least one first communication device and at least one corresponding neighbor node, wherein the at least one link metric is based on at least one transmission time corresponding to at least one physical-layer transmission parameter used for the at least one link.

In at least some embodiments, the at least one neighbor node may include a directly reachable communication device within wireless communication range of the at least one first communication device, and the at least one routing update packet may include a periodically broadcast, event-driven, or otherwise transmitted control packet that may carry routing information for one or more destinations in the ad-hoc mesh network. The route advertisements may include, for example, destination identifiers, associated route costs, hop-related information, counter values, age information, or other routing state that may enable the at least one first communication device to learn, validate, refresh, or update routes through neighboring nodes. In at least some embodiments, iteratively receiving 1130 may include repeatedly, periodically, continuously, intermittently, or opportunistically receiving such routing update packets over time so that the at least one first communication device may maintain an updated local view of reachable destinations and available forwarding paths as network conditions change.

In at least some embodiments, each routing update packet from the at least one routing update packet may be associated respectively with at least one link metric for at least one link between the at least one first communication device and at least one corresponding neighbor node, where the at least one link metric may represent a measured, estimated, inferred, calculated, or assigned value indicative of the relative performance of that link. The at least one link metric may be based on at least one transmission time corresponding to at least one physical-layer transmission parameter used for the at least one link. For example, the physical-layer transmission parameter may include a spreading factor, bandwidth, coding rate, transmit power, channel selection, symbol rate, preamble configuration, or any combination thereof, and the selected parameter or parameter set may affect time-on-air, latency, channel occupancy, reliability, and overall link behavior.

In at least some embodiments, a link using a slower physical-layer setting, such as a higher spreading factor, may be associated with a greater transmission time and therefore may be associated with a greater link metric than a link using a faster physical-layer setting, where the resulting metric may be used in later route-cost calculations for selecting preferred multi-hop paths. In this manner, the received routing update packets may provide not only destination reachability information, but also link-related timing information that may enable the at least one processor to evaluate routes based on transmission efficiency across one or more hops.

In at least some embodiments, the method 1100 may include iteratively computing 1140, by the at least one processor, from the at least one routing update packet, the at least one path cost metric as a function of at least one aggregate transmission time for multi-hop delivery.

In at least some embodiments, the at least one path cost metric may include a calculated value representing the relative suitability of a route from the at least one first communication device to a destination through one or more hops in the ad-hoc mesh network. The at least one aggregate transmission time may include a cumulative transmission time, time-on-air, delay-related value, or other combined timing value associated with successive links along a multi-hop route. In at least some embodiments, computing the at least one path cost metric may include determining, estimating, inferring, summing, weighting, or otherwise combining transmission-time-related information associated with a plurality of links so that the resulting path cost metric may reflect end-to-end forwarding performance rather than only a single-hop condition. Thus, the at least one processor may use information conveyed by the at least one routing update packet to derive a route cost that may correspond to how long a packet may take to traverse multiple links to reach the destination identifier.

In at least some embodiments, the at least one routing update packet may convey route advertisements and associated route information that may enable the at least one processor to compute a multi-hop cost based on transmission-time behavior of successive links. For example, a link metric associated with a direct neighbor link may be based on transmission time corresponding to a selected physical-layer transmission parameter, such as a spreading factor, bandwidth, coding rate, transmit power, channel selection, symbol rate, preamble configuration, or any combination thereof, and the at least one processor may combine that link metric with advertised downstream route information to determine the at least one aggregate transmission time for a candidate route. In at least some embodiments, where higher spreading factors may be associated with longer time-on-air, links using such higher spreading factors may contribute greater amounts to the aggregate transmission time than links using lower spreading factors. The computed path cost metric therefore may include a time-on-air metric or other transmission-time-based metric that may favor routes having lower end-to-end transmission time, lower channel occupancy, lower energy expenditure, or otherwise improved forwarding efficiency for multi-hop delivery in the LoRa-based mesh network.

In at least some embodiments, iteratively computing 1140 may include repeatedly, periodically, continuously, intermittently, opportunistically, or event-drivenly recalculating the at least one path cost metric as additional routing update packets may be received and as network conditions may change over time. The at least one processor may recalculate path cost metrics when neighbor links may change, when route advertisements may be added or withdrawn, when physical-layer transmission parameters may change for one or more links, when topology may change due to node addition, departure, mobility, or failure, or when congestion, interference, packet loss, or duty-cycle conditions may affect transmission time. In this manner, the at least one first communication device may maintain path cost metrics that may track current multi-hop transmission conditions and may support later selection of a next-hop neighbor identifier associated with a comparatively lower computed path cost metric.

In at least some embodiments, the method 1100 may include iteratively forwarding 1150, by the at least one processor, based on the at least one routing table, at least one data packet toward the at least one destination identifier via a selected next-hop neighbor identifier associated with a lower computed path cost metric than at least one alternative next-hop neighbor identifier.

In at least some embodiments, the at least one data packet may include any suitable payload-bearing packet, message, frame, user-data unit, application-layer message container, sensor-data packet, command packet, alert packet, or other packetized information intended for delivery to another node in the ad-hoc mesh network. The at least one destination identifier may identify an intended recipient node, and the selected next-hop neighbor identifier may identify a neighboring node through which the at least one data packet may be forwarded as part of a direct or multi-hop route. In at least some embodiments, forwarding based on the at least one routing table may include accessing a stored association between the at least one destination identifier and a preferred next-hop neighbor identifier, and may further include causing the LoRa low-power radio transceiver to transmit the at least one data packet toward the selected neighboring node for onward delivery through the network.

In at least some embodiments, the comparatively lower computed path cost metric may include a route cost that is lower relative to one or more other candidate route costs available for reaching the same destination identifier. For example, the at least one processor may compare a plurality of candidate next-hop neighbor identifiers and may select a particular next-hop neighbor identifier associated with a lower aggregate transmission time, lower time-on-air, lower latency, lower channel occupancy, lower energy expenditure, greater reliability, or otherwise improved forwarding suitability. In at least some embodiments, the comparatively lower computed path cost metric may be determined using transmission-time-based link metrics associated with respective links, where the selected route may correspond to a route expected to provide more efficient multi-hop delivery than one or more alternative routes. Such selection may but need not always require choosing an absolute minimum numerical value, and may include selecting among tied, substantially similar, threshold-qualified, policy-preferred, or otherwise acceptable lower-cost routes according to implementation preferences.

In at least some embodiments, iteratively forwarding 1150 may include repeatedly, periodically, continuously, intermittently, event-drivenly, or opportunistically forwarding packets over time as packets become available for transmission and as routing information changes. The at least one processor may repeatedly consult the at least one routing table, determine whether a route to the at least one destination identifier is available, select or confirm the next-hop neighbor identifier, encapsulate or prepare the at least one data packet for transmission, and cause wireless transmission to the selected neighboring node. In at least some embodiments, the selected next-hop neighbor identifier may change over time as routing update packets are received, as computed path cost metrics are updated, as physical-layer transmission parameters change, or as link conditions, interference conditions, congestion conditions, topology conditions, node availability, or destination reachability may change. In this manner, forwarding may dynamically track current network conditions while still using the at least one routing table as the operative basis for packet-delivery decisions.

In at least some embodiments, forwarding toward the at least one destination identifier via the selected next-hop neighbor identifier may include direct single-hop delivery when the destination is itself a neighboring node, or may include partial forwarding along a longer multi-hop route when the destination is not directly reachable. Thus, the selected next-hop neighbor identifier may but need not be the final destination node, and may instead be an intermediate relay node that may subsequently forward the at least one data packet further toward the destination. In at least some embodiments, this forwarding functionality may cooperate with route maintenance, routing update reception, and path-cost computation so that packet transmission decisions may reflect an updated local view of network topology and route efficiency within the LoRa-based ad-hoc mesh network.

In at least some embodiments, the method 1100 may include iteratively transmitting 1160, by the at least one processor, the at least one routing update packet on at least one shared channel using a plurality of different spreading factors in a non-deterministic order, where respective transmission frequencies for the plurality of different spreading factors are based on respective transmission times of the plurality of different spreading factors, thereby distributing routing information while limiting channel occupancy and reducing persistent collisions.

In at least some embodiments, the at least one routing update packet may include a control packet, broadcast packet, route advertisement packet, neighbor-update packet, or other routing-information-bearing packet that may convey destination reachability information, route costs, hop-related information, age information, or other routing state to neighboring nodes. The at least one shared channel may include a common wireless communication resource over which a plurality of nodes in the ad-hoc mesh network may transmit and receive, such as a shared LoRa channel, shared frequency resource, shared logical channel, or other common medium accessible by multiple communication devices. The plurality of different spreading factors may include two or more distinct LoRa spreading factors usable by the long-range low-power radio transceiver for routing transmissions, where different spreading factors may respectively correspond to different transmission times, data rates, ranges, robustness characteristics, and channel-occupancy effects.

In at least some embodiments, using the plurality of different spreading factors in a non-deterministic order may include selecting successive spreading factors in a randomized, pseudo-randomized, probabilistic, independently variable, or otherwise non-fixed sequence rather than in a repeating predetermined order. For example, the at least one processor may but need not select a first routing update packet for transmission using a first spreading factor and a later routing update packet using a second or third spreading factor without following a fixed progression. In at least some embodiments, different communication devices may independently randomize their respective spreading-factor selections for respective routing transmissions so that routing broadcasts across the ad-hoc mesh network may remain uncorrelated over time. Such non-deterministic ordering may help prevent neighboring nodes from becoming synchronized into repeating transmission patterns that may otherwise repeatedly overlap on the at least one shared channel.

In at least some embodiments, respective transmission frequencies for the plurality of different spreading factors may be based on respective transmission times of the plurality of different spreading factors, where a spreading factor associated with a shorter transmission time may be used more frequently than a spreading factor associated with a longer transmission time. For example, lower transmission-time spreading factors may be selected with higher relative probability, higher repetition rate, or greater occurrence frequency than higher transmission-time spreading factors so that route dissemination may be balanced against time-on-air restrictions and shared-medium utilization. In at least some embodiments, the at least one processor may determine, estimate, assign, or otherwise use transmission-time information associated with the plurality of different spreading factors in establishing how often routing update packets may be transmitted using each spreading factor. Such transmission-frequency selection may but need not be strictly proportional, and may instead include weighted selection, threshold-based selection, policy-based selection, duty-cycle-aware selection, or other selection logic that may account for the relative airtime burden associated with each spreading factor.

In at least some embodiments, transmitting routing update packets in this manner may distribute routing information while limiting channel occupancy and reducing persistent collisions. Distributing routing information may include causing route advertisements to propagate across neighboring nodes that may use different link conditions and different preferred spreading factors, thereby increasing the likelihood that routing information may reach a broader set of nodes in the ad-hoc mesh network. Limiting channel occupancy may include reducing aggregate time-on-air consumed by routing traffic by favoring faster spreading factors more often while still using slower spreading factors often enough to support longer-range or otherwise more challenging links. Reducing persistent collisions may include reducing repeated overlaps between recurring routing transmissions of different nodes by avoiding fixed spreading-factor sequences and by introducing independent randomization into successive routing broadcasts. In at least some embodiments, this transmission behavior may cooperate with the routing-table maintenance, routing-update reception, path-cost computation, and packet-forwarding functionality of the at least one first communication device so that routing control traffic may remain available while shared-channel resources may be used more efficiently.

In at least some embodiments, when the at least one routing update packet may be transmitted using a plurality of different spreading factors, the at least one processor may select a spreading factor for a given routing transmission according to a probability distribution based on respective transmission times associated with the plurality of different spreading factors, where a spreading factor associated with a shorter transmission time may be selected with greater relative probability, greater occurrence frequency, or greater repetition rate than a spreading factor associated with a longer transmission time. In at least some embodiments, such probabilistic selection may substantially equalize airtime burden across the plurality of different spreading factors, may increase routing-update availability on faster links, and may reduce excessive channel occupancy associated with repeated use of slower spreading factors.

In at least some embodiments, the at least one processor may independently randomize spreading-factor selection for successive routing update packet transmissions, where successive transmissions may but need not follow any fixed sequence, cyclic pattern, ascending order, descending order, or predetermined progression through the plurality of different spreading factors. In at least some embodiments, different nodes in the ad-hoc mesh network may perform such selection independently of one another so that transmission patterns may remain varying and substantially uncorrelated over time. Such independently variable selection behavior may reduce repeated synchronization between neighboring nodes and may thereby reduce recurring packet collisions on the at least one shared channel.

In at least some embodiments, a communication device may include a single-channel radio configured to support reception and/or transmission at any spreading factor within a selectable spreading-factor range, such as from a minimum spreading factor to a maximum spreading factor supported by the radio configuration. In at least some embodiments, the at least one processor may cause the communication device to receive routing traffic and data traffic associated with different spreading factors on the same channel without requiring a separate dedicated receiver chain for each spreading factor. Such operation may allow a node to participate in multi-spreading-factor route dissemination while using a simplified radio architecture.

In at least some embodiments, the ad-hoc mesh network may support concurrent logical networks, concurrent routing domains, and/or concurrent traffic patterns over a common wireless channel by leveraging orthogonality among different spreading factors. In at least some embodiments, routing update packets and/or data packets associated with different spreading factors may coexist on the same shared channel while still being distinguishable at participating nodes according to spreading factor, address information, channel configuration, network identifier, or any combination thereof. Such an arrangement may allow multiple groups of communication devices to share a common spectral resource while maintaining logically distinct network behavior.

In at least some embodiments, the routing protocol may include a plurality of selectable forwarding strategies and/or path-cost strategies. For example, a first strategy may include flooding in which packets may be broadcast to neighboring nodes without path optimization, a second strategy may include hop-count-based routing, a third strategy may include expected-transmission-count routing based on inferred link quality, a fourth strategy may include minimum-delay routing, a fifth strategy may include maximum-data-rate routing, and a sixth strategy may include transmission-time-based routing using a time-on-air metric. In at least some embodiments, the at least one processor may select among such strategies according to deployment configuration, node role, traffic type, link conditions, regulatory constraints, power considerations, or other operating criteria.

In at least some embodiments, packet addressing in the ad-hoc mesh network may include a local network address, a device identifier, a node identifier, a media-access identifier, a user-defined device name, or any combination thereof. In at least some embodiments, a unicast transmission may identify an intended recipient using a node-specific address value, and a broadcast transmission may identify a plurality of recipient devices using a reserved broadcast value. In at least some embodiments, a local routing domain may use a compact address space, such as a two-byte address space, while other embodiments may use a longer identifier format for device discovery, interoperability, and/or application-layer addressing. In at least some embodiments, a custom device name may be mapped to an address value so that a user-facing identifier may be used without altering underlying routing behavior.

In at least some embodiments, the ad-hoc communication network may be implemented on existing consumer devices without requiring dedicated external radio hardware for every user. A communication device may include a smartphone, tablet, wearable device, Internet-of-Things device, laptop computer, beacon device, or other portable computing device that may execute a networking application as a foreground process, background process, background service, daemon, or other software component. In at least some embodiments, the networking application may access native operating-system functions associated with Bluetooth Low Energy, Wi-Fi Direct, LoRa, and/or other wireless interfaces for device discovery, link establishment, packet exchange, topology maintenance, and route management, where network intelligence may remain distributed across application instances running on participating devices.

In at least some embodiments, the ad-hoc communication network may include LoRa-only links, Bluetooth-Low-Energy-only links, Wi-Fi-Direct-only links, or heterogeneous links using any combination thereof. In at least some embodiments, a first communication device may discover a neighboring device using Bluetooth Low Energy, may establish a peer-to-peer connection using Wi-Fi Direct, and may forward at least one packet over a LoRa link for longer-range delivery, where intermediate nodes may bridge between unlike radio technologies while maintaining an end-to-end ad-hoc mesh topology. In at least some embodiments, the at least one processor may select among available radio interfaces based on range, latency, energy consumption, bandwidth, link quality, congestion, mobility, or application requirements.

In at least some embodiments, one or more communication devices may operate in a hotspot mode in which a hotspot-enabled communication device may serve as a relay point for packet forwarding and may further act as a local distribution point for networking software. A nearby communication device that may not yet include the networking application may connect to the hotspot-enabled communication device and may receive installation data, onboarding data, update data, configuration data, or any combination thereof. In at least some embodiments, enabling such hotspot mode may facilitate organic expansion of the ad-hoc mesh network by allowing nearby devices to obtain the networking application and join the mesh using local peer-to-peer connectivity rather than relying on preexisting infrastructure.

In at least some embodiments, the system may include a plurality of deployable beacon hardware units configured to be placed throughout an environment to establish, extend, and/or reinforce the ad-hoc communication network. The deployable beacon hardware units and a plurality of mobile communication devices may collectively form a rapidly deployable pop-up mesh network in which devices may automatically discover one another, exchange configuration information, and establish multi-hop paths without requiring preexisting communication infrastructure. In at least some embodiments, such deployments may be useful in environments including emergency-response areas, remote field sites, event venues, isolated communities, and other areas in which reliable infrastructure may be unavailable, congested, compromised, or impractical to deploy.

In at least some embodiments, a communication device may periodically generate at least one location beacon including geographic location data, timestamp data, device identification data, status data, or any combination thereof, where nearby communication devices may temporarily relay the at least one location beacon through the ad-hoc mesh network. In at least some embodiments, when a path to a gateway, bridge device, or other external connectivity point may be unavailable, one or more communication devices may buffer the at least one location beacon and may later forward the buffered beacon when connectivity becomes available. Such deferred forwarding behavior may support synchronization of mesh-network data with external systems while preserving decentralized operation during infrastructure outages.

The material disclosed herein in any of the Figures, particularly FIGS. 1A-1B, may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In at least some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In at least some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In at least some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 11; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21).NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In at least some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

As used herein, the terms “cloud,” “Internet cloud,” “cloud computing,” “cloud architecture,” and similar terms applied to the LoRA mesh network described herein may correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In at least some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

The aforementioned examples are, of course, illustrative and not restrictive.

As used herein, the term “user” shall have a meaning of at least one user. In at least some embodiments, the terms “user”, “subscriber” “consumer” or “customer” should be understood to refer to a user of an application or applications for implementing the functions as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

In at least some embodiments, a method may include iteratively operating, by at least one processor of at least one first communication device having a long-range LoRa low-power radio transceiver with a selectable physical-layer transmission parameter, the at least one first communication device as a node in an ad-hoc mesh network; iteratively maintaining, by the at least one processor, in at least one memory, at least one routing table associating at least one destination identifier respectively with at least one next-hop neighbor identifier and at least one path cost metric; iteratively receiving, by the at least one processor, via the LoRa low-power radio transceiver, from at least one neighbor node, at least one routing update packet conveying route advertisements, where each routing update packet from the at least one routing update packet may be associated respectively with at least one link metric for at least one link between the at least one first communication device and at least one corresponding neighbor node, and where the at least one link metric may be based on at least one transmission time corresponding to at least one physical-layer transmission parameter used for the at least one link; iteratively computing, by the at least one processor, from the at least one routing update packet, the at least one path cost metric as a function of at least one aggregate transmission time for multi-hop delivery; iteratively forwarding, by the at least one processor, based on the at least one routing table, at least one data packet toward the at least one destination identifier via a selected next-hop neighbor identifier having a comparatively lower computed path cost metric; and iteratively transmitting, by the at least one processor, the at least one routing update packet on at least one shared channel using a plurality of different spreading factors in a non-deterministic order, where respective transmission frequencies for the plurality of different spreading factors may be based on respective transmission times of the plurality of different spreading factors, thereby distributing routing information while limiting channel occupancy and reducing persistent collisions.

In at least some embodiments, the selectable physical-layer transmission parameter may include a spreading factor.

In at least some embodiments, the at least one path cost metric may include a time-on-air metric based on spreading factors of successive links associated with a route to the at least one destination identifier.

In at least some embodiments, iteratively transmitting the at least one routing update packet may include periodically broadcasting the at least one routing update packet independently of data traffic to maintain the at least one routing table.

In at least some embodiments, iteratively transmitting the at least one routing update packet may include broadcasting the at least one routing update packet to one-hop neighbors using a reserved broadcast address.

In at least some embodiments, the reserved broadcast address may be 0xFFFF.

In at least some embodiments, iteratively forwarding the at least one data packet may include storing, in the at least one data packet, a Via field identifying the selected next-hop neighbor identifier and updating the Via field at each hop until the at least one data packet reaches the at least one destination identifier.

In at least some embodiments, when routes associated with the at least one routing table may exceed an available payload space of the at least one routing update packet, a subset of the routes may be randomly sampled for transmission based on route cost.

In at least some embodiments, the at least one routing update packet may include a counter configured to track packet loss for inferring link quality of the at least one link between the at least one first communication device and the at least one corresponding neighbor node.

In at least some embodiments, direct one-hop links between pairs of nodes may use a fastest spreading factor that enables connectivity between the pairs of nodes.

In at least some embodiments, a system may include at least one first communication device including at least one processor, at least one memory, and a long-range LoRa low-power radio transceiver with a selectable physical-layer transmission parameter, where the at least one processor may be configured to iteratively operate the at least one first communication device as a node in an ad-hoc mesh network, iteratively maintain, in the at least one memory, at least one routing table associating at least one destination identifier respectively with at least one next-hop neighbor identifier and at least one path cost metric, iteratively receive, via the LoRa low-power radio transceiver, from at least one neighbor node, at least one routing update packet conveying route advertisements, where each routing update packet from the at least one routing update packet may be associated respectively with at least one link metric for at least one link between the at least one first communication device and at least one corresponding neighbor node, and where the at least one link metric may be based on at least one transmission time corresponding to at least one physical-layer transmission parameter used for the at least one link, iteratively compute, from the at least one routing update packet, the at least one path cost metric as a function of at least one aggregate transmission time for multi-hop delivery, iteratively forward, based on the at least one routing table, at least one data packet toward the at least one destination identifier via a selected next-hop neighbor identifier having a comparatively lower computed path cost metric, and iteratively transmit the at least one routing update packet on at least one shared channel using a plurality of different spreading factors in a non-deterministic order, where respective transmission frequencies for the plurality of different spreading factors may be based on respective transmission times of the plurality of different spreading factors, thereby distributing routing information while limiting channel occupancy and reducing persistent collisions.

In at least some embodiments, the selectable physical-layer transmission parameter may include a spreading factor.

In at least some embodiments, the at least one path cost metric may include a time-on-air metric based on spreading factors of successive links associated with a route to the at least one destination identifier.

In at least some embodiments, the at least one processor may be configured to iteratively transmit the at least one routing update packet by periodically broadcasting the at least one routing update packet independently of data traffic to maintain the at least one routing table.

In at least some embodiments, the at least one processor may be configured to iteratively transmit the at least one routing update packet by broadcasting the at least one routing update packet to one-hop neighbors using a reserved broadcast address.

In at least some embodiments, the reserved broadcast address may be 0xFFFF.

In at least some embodiments, the at least one processor may be configured to iteratively forward the at least one data packet by storing, in the at least one data packet, a Via field identifying the selected next-hop neighbor identifier and updating the Via field at each hop until the at least one data packet reaches the at least one destination identifier.

In at least some embodiments, the at least one processor may be configured to, when routes associated with the at least one routing table may exceed an available payload space of the at least one routing update packet, randomly sample a subset of the routes for transmission based on route cost.

In at least some embodiments, the at least one routing update packet may include a counter configured to track packet loss for inferring link quality of the at least one link between the at least one first communication device and the at least one corresponding neighbor node.

In at least some embodiments, direct one-hop links between pairs of nodes may use a fastest spreading factor that enables connectivity between the pairs of nodes.

In at least some embodiments, a communication device may generate a local asymmetric cryptographic value pair for use as a cryptographic identity of a user, where the cryptographic identity may include a public cryptographic value and a corresponding private cryptographic value generated on the communication device without requiring a centralized identity server, a telephone number, or an account-creation process. The networking application may treat the cryptographic identity as a principal identifier for discovery, authentication, address association, message origin validation, and message destination selection across an ad-hoc communication network. In at least some embodiments, the asymmetric cryptographic value pair may include an elliptic-curve public/private value pair, such as an X25519 public/private value pair, although other public-cryptography schemes may additionally or alternatively be used.

In at least some embodiments, a first communication device may establish end-to-end encrypted messaging with a second communication device over one or more direct links, relay links, or multi-hop paths of an ad-hoc communication network, where intermediate communication devices may forward ciphertext without access to corresponding plaintext. The first communication device and the second communication device may derive a shared secret using a shared-secret agreement procedure based on their respective cryptographic identities, and one or both communication devices may derive one or more content-encryption values, nonce values, authentication values, or session parameters from the shared secret using a derivation function. In at least some embodiments, payload data may be protected using an authenticated-encryption scheme, such as ChaCha20-Poly1305, and derivation may use a cryptographic hash function, such as BLAKE3, although other authenticated-encryption schemes and hash functions may additionally or alternatively be used.

In at least some embodiments, the networking application may use an application-layer packet protocol that may operate independently of an underlying radio protocol, link protocol, or transport protocol. An application-layer packet may include a packet type field, a sequence field, a length field, and an encoded payload, where the encoded payload may include a MessagePack payload or other serialized application-layer payload. In at least some embodiments, the packet type field may identify a Discovery packet, a Handshake Init packet, a Handshake Reply packet, a Message packet, an Acknowledgment packet, a Ping packet, a Pong packet, a Read Receipt packet, a Typing Indicator packet, or another packet type used by the networking application. In at least some embodiments, the packet type field may include one byte, the sequence field may include two bytes, and the length field may include two bytes, although other field sizes and formats may additionally or alternatively be used.

In at least some embodiments, when an application-layer packet may exceed a maximum payload size supported by a selected communication link, the networking application may fragment the application-layer packet into a plurality of packet fragments for transmission across an MTU-constrained link. Each packet fragment may include a fragmentation indicator, a fragment index, a fragment count, and a group identifier associated with an original application-layer packet, where the fragmentation indicator may include a reserved marker value, such as 0xFF. A receiving communication device may buffer received packet fragments associated with a common group identifier and may reassemble the original application-layer packet when a sufficient number of packet fragments has been received.

In at least some embodiments, a communication device may locally persist outbound and inbound messages in a distributed store-and-forward message queue, where the distributed store-and-forward message queue may operate without a centralized message-delivery server. A queued message may be associated with a message state that may include pending, sent, delivered, read, failed, or another delivery-related state. In at least some embodiments, when a destination communication device may be unreachable, offline, or temporarily lacking a route, the communication device may retain the queued message in local storage and may attempt retransmission when route information, peer reachability, or link availability indicates that delivery may again be possible.

In at least some embodiments, the networking application may update a delivery state of a queued message based on receipt of one or more application-layer acknowledgment packets, read-receipt packets, timeout events, or retransmission outcomes. A communication device may retry transmission of a queued message according to a retry policy that may include exponential backoff, randomized retry timing, a configurable retry interval, a configurable send-timeout interval, or any combination thereof. In at least some embodiments, when an acknowledgment may not be received within a configurable timeout interval, such as approximately thirty seconds, the communication device may mark the queued message as failed, although later retry logic may additionally or alternatively be applied.

In at least some embodiments, the networking application may support disappearing messages using a decentralized expiration policy that may be independently enforced by participating communication devices. A message, conversation, message thread, or communication session may be associated with a time-to-live value, expiration timestamp, retention interval, or deletion policy agreed by the participating communication devices. Each communication device may store expiration metadata locally and may periodically evaluate stored messages to determine whether a deletion condition has been satisfied, where expired messages may be deleted, hidden, rendered inaccessible, cryptographically erased, or otherwise removed from local storage without requiring a server-issued delete command.

In at least some embodiments, cryptographic operations, packet-processing logic, state-management logic, queue-management logic, and local storage operations may be implemented in a shared compiled software module that may be reused across a plurality of client platforms. The shared compiled software module may be implemented in Rust or another systems-programming language and may expose a defined application-programming interface to platform-specific client software by way of a foreign function interface, language binding, wrapper layer, or other interoperability layer. In at least some embodiments, an iOS client, an Android client, or another platform-specific client may call into the shared compiled software module so that cryptographic behavior, packet formatting, state transitions, and storage semantics may remain substantially consistent across platforms from a common auditable code base.

In at least some embodiments, peer discovery and mutual authentication may occur directly between communication devices without requiring a certificate authority, credential server, domain-name service, or other centralized coordination service. A first communication device may transmit or advertise a discovery packet that may include a public cryptographic value, a username, an avatar reference, device metadata, capability metadata, or any combination thereof, and a second communication device may receive the discovery packet and may initiate a handshake procedure in response. The first communication device and the second communication device may validate received identity information, may derive a shared secret from their respective cryptographic identities, and may establish a secure application-layer communication session for subsequent message exchange over any available underlying communication link or transport.

In at least some embodiments, a method may include operating, by at least one processor of a first communication device, the first communication device in an ad-hoc communication network having a plurality of wireless interfaces that include a long-range low-power radio interface, a Bluetooth Low Energy interface, and a Wi-Fi Direct interface; discovering, by the first communication device, at least one neighboring communication device over a first wireless interface; selecting, by the first communication device, a wireless interface for connection establishment, packet forwarding, route maintenance, or any combination thereof based on availability, range, power consumption, bandwidth, latency, link quality, or any combination thereof; receiving, by the first communication device, a packet over the first wireless interface; and forwarding, by the first communication device, the packet over a second wireless interface that differs from the first wireless interface while maintaining an end-to-end ad-hoc mesh topology, where intermediate communication devices may bridge between heterogeneous radio links.

In at least some embodiments, a method may include continuously scanning, by at least one processor of an unregistered communication device, a plurality of communication channels to detect at least one network advertisement beacon emitted by at least one registered communication device of an ad-hoc mesh network; transmitting, in response to detecting the at least one network advertisement beacon, at least one join request packet requesting admission to the ad-hoc mesh network, where the at least one join request packet may include authentication credentials; authenticating, by at least one registered communication device, the at least one join request packet; assigning, in response to successful authentication, a network address to the unregistered communication device; sending configuration data to the unregistered communication device; and updating, by the unregistered communication device, at least one parameter and at least one routing table to convert the unregistered communication device into a registered communication device of the ad-hoc mesh network.

In at least some embodiments, a method may include generating, by at least one processor of a publishing communication device in an ad-hoc mesh network, a message including a header having a topic identifier associated with a data category; transmitting the message toward at least one destination over the ad-hoc mesh network; inspecting, by at least one intermediate communication device, the header to determine whether at least one downstream recipient has subscribed to the topic identifier; forwarding, by the at least one intermediate communication device, the message when the topic identifier corresponds to a subscribed topic; and dropping, by the at least one intermediate communication device, the message when the topic identifier does not correspond to a subscribed topic, where message dissemination through the ad-hoc mesh network may be filtered according to topic subscriptions.

In at least some embodiments, a method may include periodically generating, by at least one processor of a communication device in an ad-hoc mesh network, at least one location beacon including geographic location data, timestamp data, device identification data, status data, or any combination thereof; transmitting the at least one location beacon to at least one neighboring communication device for relay through the ad-hoc mesh network; buffering, by at least one communication device, the at least one location beacon when a path to a gateway, bridge device, or external connectivity point is unavailable; and forwarding, by the at least one communication device, the buffered location beacon when connectivity becomes available, where the ad-hoc mesh network may support offline location sharing and later synchronization with an external system.

In at least some embodiments, a system may include a plurality of deployable beacon hardware units and a plurality of mobile communication devices, where each deployable beacon hardware unit may include at least one processor, at least one memory, and at least one wireless communication circuitry, and where the plurality of deployable beacon hardware units and the plurality of mobile communication devices may be configured to automatically discover one another, establish communication links, exchange network configuration data, and form multi-hop communication paths in a rapidly deployable ad-hoc mesh network without reliance on preexisting communication infrastructure.

In at least some embodiments, a system may include at least one first communication device having at least one processor, at least one memory, and at least one wireless communication circuitry, where the at least one processor may be configured to encrypt at least one message payload using a symmetric encryption algorithm, protect at least one session key or message key using a public-key encryption algorithm associated with an intended recipient communication device, transmit the encrypted message payload through an ad-hoc mesh network by way of one or more intermediate relay communication devices, and derive at least one shared session key using ephemeral key material for a communication session, where compromise of a long-term key may not permit retroactive decryption of payload data encrypted using prior session keys.

In at least some embodiments, a system may include at least one hotspot-enabled communication device in an ad-hoc mesh network, where the hotspot-enabled communication device may include at least one processor, at least one memory, and at least one wireless communication circuitry, and where the at least one processor may be configured to operate the hotspot-enabled communication device in a hotspot mode that may relay packets between other communication devices and may further provide installation data, onboarding data, update data, configuration data, or any combination thereof for a networking application to a nearby communication device that does not currently include the networking application, such that the nearby communication device may obtain the networking application and may join the ad-hoc mesh network using local peer-to-peer connectivity.

In at least some embodiments, a system may include at least one gateway communication device coupled to an ad-hoc mesh network and to an external network, where the at least one gateway communication device may include at least one long-range radio, at least one additional network interface associated with the external network, at least one processor, and at least one memory, and where the at least one processor may be configured to receive data from at least one communication device of the ad-hoc mesh network, relay the data between the ad-hoc mesh network and the external network, and forward externally received data back into the ad-hoc mesh network, such that peer-relayed mesh communications may be selectively bridged to Internet or external IP connectivity.

In at least some embodiments, a method may include selecting, by at least one processor of a communication device in an ad-hoc mesh network, a forwarding path for a packet based on link cost information and context information, where the context information may include current device location, device role, battery level, congestion state, mobility state, hotspot availability, beacon availability, gateway reachability, message type, message priority, or any combination thereof; updating at least one routing decision based on changes in the context information; and forwarding the packet according to the updated routing decision to improve delivery reliability, power efficiency, latency, coverage, or any combination thereof under changing operating conditions.

In at least some embodiments, a method may include detecting, by at least one processor of a first communication device in an ad-hoc mesh network, an intended departure of a second communication device or a loss of connectivity to the second communication device; updating at least one routing table to mark the second communication device as unreachable; propagating network-topology information associated with the departure or the loss of connectivity to other communication devices in the ad-hoc mesh network; reclaiming network resources associated with the second communication device when a disconnection is determined to be permanent; and preserving device information for the second communication device when the disconnection is determined to be temporary so that reconnection may occur without full network re-registration.

In at least some embodiments, a method may include generating, by at least one processor of a first communication device, a local asymmetric cryptographic pair including a public component and a private component at the first communication device, where the local asymmetric cryptographic pair may define a cryptographic identity associated with the first communication device. The method may further include transmitting, by the first communication device over an ad-hoc communication network, a discovery packet including the public component and device metadata, receiving, by the first communication device from a second communication device, handshake data associated with a second cryptographic identity of the second communication device, deriving, by the at least one processor based on the local asymmetric cryptographic pair and the second cryptographic identity, a shared secret for a secure communication session between the first communication device and the second communication device, encrypting, by the at least one processor, an application-layer message using at least one content-encryption value derived from the shared secret to generate encrypted payload data unreadable by one or more intermediate relay communication devices, encapsulating, by the at least one processor, the encrypted payload data in an application-layer packet, storing, by the at least one processor in at least one memory of the first communication device, the application-layer packet in a local message queue associated with a delivery state, forwarding, by the first communication device, the application-layer packet over the ad-hoc communication network toward the second communication device by way of the one or more intermediate relay communication devices, and, responsive to determining that the second communication device is unreachable, retaining the application-layer packet in the local message queue and retransmitting the application-layer packet after determining that a route toward the second communication device is available.

In at least some embodiments, the cryptographic identity may be used for discovery, authentication, and message destination selection in the ad-hoc communication network independently of a telephone number and independently of an account-creation process. A communication device may locally generate and store the cryptographic identity without registering the communication device or a user with a centralized identity service, and neighboring communication devices may use exchanged cryptographic identity information to identify one another, authenticate handshake data, and associate encrypted message traffic with intended destinations across the ad-hoc communication network. In at least some embodiments, the cryptographic identity may function as a persistent logical identity for peer-to-peer communication while remaining decoupled from carrier-managed identifiers, cloud-managed accounts, or other infrastructure-dependent identity mechanisms.

In at least some embodiments, an application-layer packet may include a packet type field, a sequence field, a length field, and an encoded payload, where the packet type field may identify a packet category associated with discovery signaling, handshake signaling, message delivery, acknowledgment processing, read-receipt processing, typing-state signaling, keepalive signaling, or other application-layer communication behavior. In at least some embodiments, when the application-layer packet may exceed a maximum payload size of a selected communication link, a communication device may fragment the application-layer packet into a plurality of packet fragments, where each packet fragment may include a fragmentation indicator, a fragment index, a fragment count, and a group identifier associated with the application-layer packet, and where a receiving communication device may buffer and reassemble received packet fragments associated with a common group identifier. The encoded payload may include a serialized application-layer payload formatted according to MessagePack or another compact serialization format.

In at least some embodiments, a communication device may maintain, in at least one memory, a delivery state associated with an application-layer packet or an application-layer message stored in a local message queue. The communication device may update the delivery state based on receipt of an acknowledgment packet, a read-receipt packet, or both, and the delivery state may indicate pending delivery, successful transmission, delivery confirmation, read status, failure status, retry eligibility, or any combination thereof. Such state management may allow the communication device to track message progress across direct links or multi-hop paths of the ad-hoc communication network and may further allow the communication device to distinguish between transmission success at an intermediate stage and confirmed receipt or viewing at a destination stage.

In at least some embodiments, a communication device may retry transmission of an application-layer packet according to a retry policy, where the retry policy may include an exponential backoff, a configurable send-timeout interval, or both. The communication device may determine that retransmission is appropriate based on a lack of acknowledgment, a detected route interruption, a link-quality condition, a peer-availability condition, or any combination thereof, and may delay successive retransmission attempts according to a progressively increasing retry interval so as to reduce repeated channel usage while preserving message-delivery reliability. In at least some embodiments, the communication device may retain the application-layer packet in the local message queue while a retry condition remains active and may update the delivery state when a retry attempt succeeds, times out, or is abandoned according to policy.

In at least some embodiments, a communication device may store expiration metadata associated with an application-layer message and may autonomously delete or render inaccessible the application-layer message when a deletion condition defined by the expiration metadata is satisfied. The expiration metadata may include a time-to-live value, an expiration timestamp, a retention duration, a conversation-specific deletion policy, a sender-selected deletion parameter, a recipient-selected deletion parameter, or any combination thereof, and the communication device may enforce deletion locally without requiring a centralized deletion instruction. In at least some embodiments, deriving the shared secret may include performing an elliptic-curve shared-secret agreement procedure using X25519, and encrypting the application-layer message may include applying ChaCha20-Poly1305 using derived material generated using BLAKE3, although other cryptographic procedures may additionally or alternatively be used.

In at least some embodiments, a system may include at least one first communication device including at least one processor and at least one memory, where the at least one processor may be configured to generate a local asymmetric cryptographic pair including a public component and a private component at the first communication device, where the local asymmetric cryptographic pair may define a cryptographic identity associated with the first communication device. The at least one processor may be further configured to transmit, over an ad-hoc communication network, a discovery packet including the public component and device metadata, receive from a second communication device handshake data associated with a second cryptographic identity of the second communication device, derive based on the local asymmetric cryptographic pair and the second cryptographic identity a shared secret for a secure communication session between the first communication device and the second communication device, encrypt an application-layer message using at least one content-encryption value derived from the shared secret to generate encrypted payload data unreadable by one or more intermediate relay communication devices, encapsulate the encrypted payload data in an application-layer packet, store the application-layer packet in a local message queue associated with a delivery state, forward the application-layer packet over the ad-hoc communication network toward the second communication device by way of the one or more intermediate relay communication devices, and, responsive to determining that the second communication device is unreachable, retain the application-layer packet in the local message queue and retransmit the application-layer packet after determining that a route toward the second communication device is available.

In at least some embodiments, a system may include one or more communication devices configured to use a cryptographic identity for discovery, authentication, and message destination selection in an ad-hoc communication network independently of a telephone number and independently of an account-creation process. At least one processor of a communication device may generate and store the cryptographic identity locally without registration with a centralized identity service, and the communication device may exchange cryptographic identity information with neighboring communication devices to authenticate handshake data and to associate encrypted message traffic with intended destinations. In at least some embodiments, the system may support peer identity establishment and message addressing based on locally controlled cryptographic material rather than network-assigned subscriber identifiers or centrally provisioned user accounts.

In at least some embodiments, a system may include at least one processor and at least one memory configured to generate, process, store, transmit, receive, fragment, buffer, and reassemble an application-layer packet including a packet type field, a sequence field, a length field, and an encoded payload. The packet type field may identify a packet category associated with discovery signaling, handshake signaling, message delivery, acknowledgment processing, read-receipt processing, typing-state signaling, keepalive signaling, or other application-layer communication behavior. In at least some embodiments, when the application-layer packet may exceed a maximum payload size of a selected communication link, the at least one processor may fragment the application-layer packet into a plurality of packet fragments, where each packet fragment may include a fragmentation indicator, a fragment index, a fragment count, and a group identifier associated with the application-layer packet, and where the at least one processor may buffer and reassemble received packet fragments associated with a common group identifier.

In at least some embodiments, a system may include at least one processor and at least one memory configured to maintain a delivery state associated with an application-layer packet or an application-layer message stored in a local message queue. The at least one processor may update the delivery state based on receipt of an acknowledgment packet, a read-receipt packet, or both, and the delivery state may indicate pending delivery, successful transmission, delivery confirmation, read status, failure status, retry eligibility, or any combination thereof. Such state management may allow the system to track message progress across direct links or multi-hop paths of the ad-hoc communication network and may further support coordinated queue handling, user-interface status presentation, and delivery-related control logic within the communication device.

In at least some embodiments, a system may include at least one processor configured to retry transmission of an application-layer packet according to a retry policy, where the retry policy may include an exponential backoff, a configurable send-timeout interval, or both. The at least one processor may determine that retransmission is appropriate based on a lack of acknowledgment, a detected route interruption, a link-quality condition, a peer-availability condition, or any combination thereof, and may delay successive retransmission attempts according to a progressively increasing retry interval so as to reduce repeated channel usage while preserving message-delivery reliability. In at least some embodiments, the system may retain the application-layer packet in local storage during a retry period and may selectively trigger retransmission after detecting restoration of reachability or availability of a suitable forwarding path.

In at least some embodiments, a system may include at least one processor and at least one memory configured to store expiration metadata associated with an application-layer message and to autonomously delete or render inaccessible the application-layer message when a deletion condition defined by the expiration metadata is satisfied. The expiration metadata may include a time-to-live value, an expiration timestamp, a retention duration, a conversation-specific deletion policy, a sender-selected deletion parameter, a recipient-selected deletion parameter, or any combination thereof, and the at least one processor may enforce deletion locally without requiring a centralized deletion instruction. In at least some embodiments, the at least one processor may derive a shared secret by performing an elliptic-curve shared-secret agreement procedure using X25519, and may encrypt the application-layer message by applying ChaCha20-Poly1305 using derived material generated using BLAKE3, although other cryptographic procedures may additionally or alternatively be used.

Throughout the specification and claims, the following terms take the meanings explicitly associated herein, unless the context clearly dictates otherwise. The phrases “in one embodiment,” “in an embodiment,” and “in some embodiments”” as used herein do not necessarily refer to the same embodiment(s), though they may. Furthermore, the phrases “in another embodiment” and “in some other embodiments” as used herein do not necessarily refer to a different embodiment, although they may. Thus, as described herein, various embodiments of the invention may be readily combined, without departing from the scope or spirit of the invention.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

While a number of embodiments of the present invention have been described, it is understood that these embodiments are illustrative only, and not restrictive, and that many modifications may become apparent to those of ordinary skill in the art. For example, any dimensions discussed herein are provided as examples only, and are intended to be illustrative and not restrictive.

1. A method, comprising:
iteratively operating, by at least one processor of at least one first communication device having a long-range (LoRa) low-power radio transceiver with a selectable physical-layer transmission parameter, the at least one first communication device as a node in an ad-hoc mesh network;
iteratively maintaining, by the at least one processor, in at least one memory, at least one routing table associating at least one destination identifier respectively with at least one next-hop neighbor identifier and at least one path cost metric;
iteratively receiving, by the at least one processor, via the LoRa low-power radio transceiver, from at least one neighbor node, at least one routing update packet conveying route advertisements;
wherein each routing update packet from the at least one routing update packet is associated respectively with at least one link metric for at least one link between the at least one first communication device and at least one corresponding neighbor node;
wherein the at least one link metric is based on at least one transmission time corresponding to at least one physical-layer transmission parameter used for the at least one link;
iteratively computing, by the at least one processor, from the at least one routing update packet, the at least one path cost metric as a function of at least one aggregate transmission time for multi-hop delivery;
iteratively forwarding, by the at least one processor, based on the at least one routing table, at least one data packet toward the at least one destination identifier via a selected next-hop neighbor identifier associated with a lower computed path cost metric than at least one alternative next-hop neighbor identifier; and
iteratively transmitting, by the at least one processor, the at least one routing update packet on at least one shared channel using a plurality of different spreading factors in a non-deterministic order;
wherein respective transmission frequencies for the plurality of different spreading factors are based on respective transmission times of the plurality of different spreading factors, thereby distributing routing information while limiting channel occupancy and reducing persistent collisions.

2. The method of claim 1, wherein the selectable physical-layer transmission parameter comprises a spreading factor.

3. The method of claim 2, wherein the at least one path cost metric comprises a time-on-air metric based on spreading factors of successive links associated with a route to the at least one destination identifier.

4. The method of claim 1, wherein iteratively transmitting the at least one routing update packet comprises periodically broadcasting the at least one routing update packet independently of data traffic to maintain the at least one routing table.

5. The method of claim 4, wherein iteratively transmitting the at least one routing update packet comprises broadcasting the at least one routing update packet to one-hop neighbors using a reserved broadcast address.

6. The method of claim 5, wherein the reserved broadcast address is 0xFFFF.

7. The method of claim 1, wherein iteratively forwarding the at least one data packet comprises storing, in the at least one data packet, a Via field identifying the selected next-hop neighbor identifier and updating the Via field at each hop until the at least one data packet reaches the at least one destination identifier.

8. The method of claim 1, wherein, when routes associated with the at least one routing table exceed an available payload space of the at least one routing update packet, a subset of the routes is randomly sampled for transmission based on route cost.

9. The method of claim 1, wherein the at least one routing update packet comprises a counter configured to track packet loss for inferring link quality of the at least one link between the at least one first communication device and the at least one corresponding neighbor node.

10. The method of claim 1, wherein direct one-hop links between pairs of nodes use a fastest spreading factor that enables connectivity between the pairs of nodes.

11. A system, comprising:
at least one first communication device, comprising:
at least one processor;
at least one memory; and
a long-range (LoRa) low-power radio transceiver with a selectable physical-layer transmission parameter;
wherein the at least one processor is configured to:
iteratively operate the at least one first communication device as a node in an ad-hoc mesh network;
iteratively maintain, in the at least one memory, at least one routing table associating at least one destination identifier respectively with at least one next-hop neighbor identifier and at least one path cost metric;
iteratively receive, via the LoRa low-power radio transceiver, from at least one neighbor node, at least one routing update packet conveying route advertisements;
wherein each routing update packet from the at least one routing update packet is associated respectively with at least one link metric for at least one link between the at least one first communication device and at least one corresponding neighbor node;
wherein the at least one link metric is based on at least one transmission time corresponding to at least one physical-layer transmission parameter used for the at least one link;
iteratively compute, from the at least one routing update packet, the at least one path cost metric as a function of at least one aggregate transmission time for multi-hop delivery;
iteratively forward, based on the at least one routing table, at least one data packet toward the at least one destination identifier via a selected next-hop neighbor identifier associated with a lower computed path cost metric than at least one alternative next-hop neighbor identifier; and
iteratively transmit the at least one routing update packet on at least one shared channel using a plurality of different spreading factors in a non-deterministic order;
wherein respective transmission frequencies for the plurality of different spreading factors are based on respective transmission times of the plurality of different spreading factors, thereby distributing routing information while limiting channel occupancy and reducing persistent collisions.

12. The system of claim 11, wherein the selectable physical-layer transmission parameter comprises a spreading factor.

13. The system of claim 12, wherein the at least one path cost metric comprises a time-on-air metric based on spreading factors of successive links associated with a route to the at least one destination identifier.

14. The system of claim 11, wherein the at least one processor is configured to iteratively transmit the at least one routing update packet by periodically broadcasting the at least one routing update packet independently of data traffic to maintain the at least one routing table.

15. The system of claim 14, wherein the at least one processor is configured to iteratively transmit the at least one routing update packet by broadcasting the at least one routing update packet to one-hop neighbors using a reserved broadcast address.

16. The system of claim 15, wherein the reserved broadcast address is 0xFFFF.

17. The system of claim 11, wherein the at least one processor is configured to iteratively forward the at least one data packet by storing, in the at least one data packet, a Via field identifying the selected next-hop neighbor identifier and updating the Via field at each hop until the at least one data packet reaches the at least one destination identifier.

18. The system of claim 11, wherein the at least one processor is configured to, when routes associated with the at least one routing table exceed an available payload space of the at least one routing update packet, randomly sample a subset of the routes for transmission based on route cost.

19. The system of claim 11, wherein the at least one routing update packet comprises a counter configured to track packet loss for inferring link quality of the at least one link between the at least one first communication device and the at least one corresponding neighbor node.

20. The system of claim 11, wherein direct one-hop links between pairs of nodes use a fastest spreading factor that enables connectivity between the pairs of nodes.

21. A method, comprising:
generating, by at least one processor of a first communication device, a local asymmetric cryptographic pair comprising a public component and a private component at the first communication device, the local asymmetric cryptographic pair defining a cryptographic identity associated with the first communication device;
transmitting, by the first communication device, over an ad-hoc communication network, a discovery packet including the public component and device metadata;
receiving, by the first communication device from a second communication device, handshake data associated with a second cryptographic identity of the second communication device;
deriving, by the at least one processor based on the local asymmetric cryptographic pair and the second cryptographic identity, a shared secret for a secure communication session between the first communication device and the second communication device;
encrypting, by the at least one processor, an application-layer message using at least one content-encryption value derived from the shared secret to generate encrypted payload data unreadable by one or more intermediate relay communication devices;
encapsulating, by the at least one processor, the encrypted payload data in an application-layer packet; storing, by the at least one processor in at least one memory of the first communication device, the application-layer packet in a local message queue associated with a delivery state;
forwarding, by the first communication device, the application-layer packet over the ad-hoc communication network toward the second communication device by way of the one or more intermediate relay communication devices; and
responsive to determining that the second communication device is unreachable:
retaining the application-layer packet in the local message queue; and
retransmitting the application-layer packet after determining that a route toward the second communication device is available.

22. The method of claim 21, wherein the cryptographic identity is used for discovery, authentication, and message destination selection in the ad-hoc communication network independently of a telephone number and independently of an account-creation process.

23. The method of claim 21, wherein the application-layer packet comprises a packet type field, a sequence field, a length field, and an encoded payload.

24. The method of claim 23, wherein, when the application-layer packet exceeds a maximum payload size of a selected communication link, the first communication device fragments the application-layer packet into a plurality of packet fragments, each packet fragment comprising a fragmentation indicator, a fragment index, a fragment count, a group identifier associated with the application-layer packet, or any combination thereof.

25. The method of claim 21, further comprising updating, by the at least one processor, the delivery state based on receipt of an acknowledgment packet or a read-receipt packet.

26. The method of claim 21, further comprising retrying, by the at least one processor, transmission of the application-layer packet according to a retry policy; wherein the retry policy comprises an exponential backoff, a configurable send-timeout interval, or both.

27. The method of claim 21, further comprising storing, by the at least one processor, expiration metadata associated with the application-layer message and autonomously deleting or rendering inaccessible, by the at least one processor, the application-layer message when a deletion condition defined by the expiration metadata is satisfied.

28. The method of claim 21, wherein the deriving the shared secret comprises performing an elliptic-curve shared-secret agreement procedure using X25519, and wherein the encrypting the application-layer message comprises applying ChaCha20-Poly1305 using derived material generated using BLAKE3.
